(19) United States
(12) Patent Application Publication
(10) Pub. No.: US 2020/0394625 A1
(43) Pub. Date: Dec. 17, 2020

(54) Method and System for Facilitating Transactions

(71) Applicant: Mastercard International Incorporated, Purchase, NY (US)

(72) Inventors: Harsh Piparsaniya, Pune (IN); Sudhir Gupta, Pune (IN); Rahul Agrawal, Pune (IN)

(21) Appl. No.: 16/897,219

(22) Filed: Jun. 9, 2020

(30) Foreign Application Priority Data
Jun. 11, 2019 (SG) 10201905292W

(51) Int. Cl. G06Q 20/10; G06Q 20/22; G06Q 20/36

(52) U.S. Cl. CPC G06Q 20/102; G06Q 20/36; G06Q 20/29

(57) ABSTRACT

A method for facilitating transactions includes creation of a first virtual group, including a plurality of group members, by a server. The server adds, to the first virtual group, payment modes of the group members. The server receives a transaction request for a transaction associated with a first group member of the first virtual group. The server selects a first set of payment modes suitable for the transaction from the payment modes added to the first virtual group. The server renders, on a first device of the first group member, a graphical interface for presenting the first set of payment modes to the first group member for selection. The server initiates the transaction using a first payment mode selected by the first group member from the first set of payment modes. The first payment mode is associated with a second group member of the first virtual group.

### FIELD

The present disclosure relates to the field of electronic transactions, and, more particularly to a method and a system for facilitating electronic transactions.

### BACKGROUND

Proliferation of Internet has led to emergence and evolution of payment modes that enable users to perform cashless transactions (e.g., purchases of products and/or services from merchants). Examples of such payment modes include digital wallets, transaction cards (such as debit cards and credit cards), or the like. Different payment modes may differ on various parameters such as credit limit, benefits on performing transactions, or the like. For example, a first transaction card of a first user may have a credit limit that is lower than a credit limit of a second transaction card of a second user. Thus, if the first user wants to purchase a product for which the purchase amount is greater than the credit limit of the first transaction card, the first user may be unable to purchase the product using the first transaction card. Likewise, there may be an offer (e.g., a discount offer, a cashback offer, or a reward points offer) available on transactions performed using the first transaction card, while there may be no such offer available for the second transaction card. Thus, the first user may avail the offer by using the first transaction card and the second user having the second transaction card may be unable to avail any such offer.

A known solution for users to overcome the abovementioned problem is to maintain different types of payment modes. However, in certain scenarios, the users may be required to pay maintenance charges (e.g., annual or monthly charges) for maintaining the payment modes. Consequently, maintaining multiple payment modes becomes cumbersome and, sometimes, an expensive affair for the users. Thus, each user may only maintain a limited number of payment modes. As a result, the users may not be able to avail any benefits associated with the other payment modes that they don't have. In one scenario, the first user may not have a suitable payment mode for performing a transaction, and an acquaintance of the first user may possess the suitable payment mode. With the permission of the acquaintance, the first user may be able to perform the transaction using the payment mode of the acquaintance. However, obtaining the permission of the acquaintance is a time consuming and cumbersome task. Further, in case of an emergency, the first user may not have any extra time to spare. Thus, obtaining the permission of the acquaintance becomes impracticable, which may cause inconvenience to the first user.

In light of the foregoing, there is a need for a technical solution that enables a user to perform a transaction even when the user does not possess a suitable payment mode required for the transaction.

### SUMMARY

In an embodiment of the present disclosure, a method for facilitating transactions is provided. The method includes creating, by a server, a first virtual group including a plurality of group members. A plurality of payment modes of the plurality of group members are added to the first virtual group by the server. A transaction request for a transaction associated with a first group member of the first virtual group is received by the server. From the plurality of payment modes, a first set of payment modes suitable for the transaction is selected by the server. A graphical interface for presenting the first set of payment modes to the first group member for selection is rendered by the server on a first device of the first group member. The transaction is initiated by the server using a first payment mode selected by the first group member from the first set of payment modes. The first payment mode selected by the first group member is associated with a second group member of the first virtual group.

In another embodiment of the present disclosure, a system for facilitating transactions is provided. The system includes a server that is configured to create a first virtual group including a plurality of group members. The server adds, to the first virtual group, a plurality of payment modes of the plurality of group members. The server receives a transaction request for a transaction associated with a first group member of the first virtual group. The server selects, from the plurality of payment modes, a first set of payment modes suitable for the transaction. The server renders, on a first device, a graphical interface for presenting the first set of payment modes to the first group member for selection. The server initiates the transaction using a first payment mode selected by the first group member from the first set of payment modes. The first payment mode selected by the first group member is associated with a second group member of the first virtual group.

### BRIEF DESCRIPTION OF THE DRAWINGS

Various embodiments of the present disclosure are illustrated by way of example, and not limited by the appended figures, in which like references indicate similar elements, and in which:

FIG. 1 is a block diagram that illustrates an exemplary environment for facilitating transactions, in accordance with an exemplary embodiment of the disclosure;

FIGS. 2A and 2B, collectively represent a process flow diagram that illustrates an exemplary scenario for creating a first virtual group, in accordance with an exemplary embodiment of the disclosure;

FIGS. 3A and 3B, collectively represent a process flow diagram that illustrates an exemplary scenario for adding group members to the first virtual group, in accordance with an exemplary embodiment of the disclosure;

FIG. 4 is a Table that illustrates details of virtual groups stored in a database maintained at a payment network server of FIG. 1, in accordance with an exemplary embodiment of the disclosure;

FIGS. 5A-5C, collectively represent a process flow diagram that illustrates an exemplary scenario for facilitating a transaction, in accordance with an exemplary embodiment of the disclosure;

FIG. 6 represents a process flow diagram that illustrates an exemplary scenario for settling a transaction amount of the transaction of FIG. 5, in accordance with an exemplary embodiment of the disclosure;

FIGS. 7A-7C, collectively represent a process flow diagram that illustrates an exemplary scenario for facilitating a transaction, in accordance with another exemplary embodiment of the disclosure;

FIG. 8 represents a process flow diagram that illustrates an exemplary scenario for settling a transaction amount of the transaction of FIG. 7, in accordance with an exemplary embodiment of the disclosure;

FIGS. 9A and 9B, collectively represent an exemplary scenario that illustrates user interface (UI) screens rendered on a first device of FIG. 1, in accordance with an exemplary embodiment of the disclosure;

FIGS. 10A and 10B, collectively represent an exemplary scenario that illustrates UI screens rendered on the first device, in accordance with another exemplary embodiment of the disclosure;

FIG. 11 is a block diagram that illustrates the payment network server, in accordance with an exemplary embodiment of the disclosure;

FIGS. 12A and 12B, collectively represent a flow chart that illustrates a method for creating a virtual group, in accordance with an exemplary embodiment of the disclosure;

FIGS. 13A and 13B, collectively represent a flow chart that illustrates the method for adding group members to a virtual group, in accordance with another exemplary embodiment of the disclosure;

FIGS. 14A-14C, collectively represent a flow chart that illustrates the method for facilitating transactions, in accordance with another exemplary embodiment of the disclosure;

FIG. 15 represents a high-level flow chart that illustrates the method for facilitating transactions, in accordance with another exemplary embodiment of the disclosure; and

FIG. 16 is block diagram that illustrates system architecture of a computer system, in accordance with an exemplary embodiment of the disclosure.

Further areas of applicability of the disclosure will become apparent from the detailed description provided hereinafter. It should be understood that the detailed description of exemplary embodiments is intended for illustration purposes only and is, therefore, not intended to necessarily limit the scope of the disclosure.

### DETAILED DESCRIPTION

The disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### Overview

A first user may not possess a suitable payment mode required for performing a transaction. In one example, a credit limit of a payment mode of the first user may be insufficient to cover a purchase amount of a product. In another example, the payment mode of the first user may not be eligible for an offer (e.g., a discount offer, a cashback offer, or a reward points offer) available on the purchase of the product. Thus, the first user is inconvenienced.

Various embodiments of the disclosure provide a method and a system that solve the abovementioned problem by enabling the first user to use a payment mode of another user that is suitable for performing the transaction. The system of the disclosure includes a server that hosts a service application for providing a transaction service to users. Examples of the server may include, but are not limited to, a payment network server, an issuer server, a third-party server, a social media server, or the like. The service application may be accessed by the first user on a first device for initiating a group creation request. Based on the group creation request initiated by the first user, the server creates a first virtual group that includes various group members (e.g., the first user, a second user, and a third user). The server automatically adds the first user, who initiated the creation of the first virtual group, as a group member to the first virtual group. The second and third users may be added to the first virtual group based on an invite from the first user. For example, the first user may use the service application to invite the second and third users for joining the first virtual group. The server communicates invitations to the second and third users for joining the first virtual group. Based on acceptances of the invitations by the second and third users, the server adds the second and third users to the first virtual group as group members. The server further adds one or more payment modes of all the group members to the first virtual group. Each payment mode is one of a transaction card or a digital wallet.

A first group member of the first virtual group may attempt to perform a first transaction by using the service application. Since the service application serves as a gateway to the server, the server receives a first transaction request for the first transaction. The first transaction request is indicative of a transaction amount of the first transaction. Based on the first transaction request, the server identifies that the first group member is a group member of the first virtual group. The server then selects a first set of payment modes that are suitable for the first transaction from the payment modes that are added to the first virtual group. The selection of the first set of payment modes is based on at least one of the transaction amount of the first transaction, an eligibility of the first set of payment modes to avail one or more benefits on the first transaction, or a credit limit of each of the first set of payment modes. The server then renders a graphical interface on the first device for presenting the first set of payment modes to the first group member, for selection. The first group member may select, from the first set of payment modes, a first payment mode associated with a second group member of the first virtual group. Based on the selection of the first payment mode, the server communicates, to a device of the second group member, an approval request for requesting an approval for using the first payment mode for initiating the first transaction. The server receives, from the device of the second group member, an approval response based on the approval request. The approval response indicates the approval of the second group member for using the first payment mode for initiating the first transaction. Based on the approval response, the server initiates the first transaction by using the first payment mode. After the first transaction is processed, the server facilitates a settlement between the first and second group members for the transaction amount of the first transaction.

Thus, the method and system of the disclosure enable the first user to use a payment mode of another user, who is a group member of the first virtual group, to perform transactions conveniently.

### Terms Description (in Addition to Plain and Dictionary Meaning)

Virtual group is a virtual cluster of a plurality of users. The plurality of users are group members of the virtual group. The virtual group enables the group members to pool-in their payment modes. The group members of the virtual group are allowed to use any payment mode from the pooled-in payment modes for performing transactions.

Payment mode is means of payment that allows a user to perform transactions for purchasing products and/or services from merchants. The payment mode may be a transaction card or a digital wallet. Examples of the transaction card may include, but are not limited to, virtual and physical debit cards, credit cards, loyalty cards, or the like.

Transaction request is a request that is generated based on a transaction performed by a user. The transaction request may indicate a transaction amount of the transaction, a product category, or the like. For example, a transaction request may be generated when the user initiates a purchase of a mobile phone. The transaction request may indicate a transaction amount (i.e., a price of the mobile phone), a product category (e.g., ‘Electronics’), or the like.

Issuer is a financial institution which establishes and maintains user accounts of several users. The issuer authorizes and settles transactions in accordance with various payment network regulations and local legislation.

Payment networks, such as those operated by Mastercard®, process transactions between acquirers and issuers. Processing by a payment network includes steps of authorization, clearing, and settlement.

Server is a physical or cloud data processing system on which a server program runs. The server may be implemented in hardware or software, or a combination thereof. In one embodiment, the server may be implemented in computer programs executing on programmable computers, such as personal computers, laptops, or a network of computer systems. The server may correspond to one of an acquirer server, a payment network server, or an issuer server.

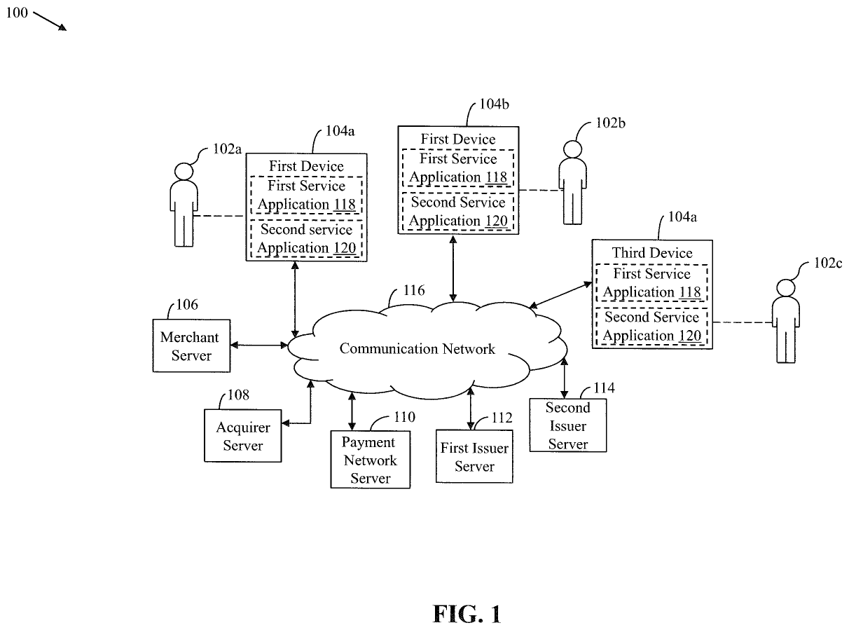

FIG. 1 is a block diagram that illustrates an exemplary environment 100 for facilitating transactions, in accordance with an exemplary embodiment of the disclosure. The environment 100 includes first through third users 102a-102c in possession of first through third devices 104a-104c, respectively. The environment 100 further includes a merchant server 106, an acquirer server 108, a payment network server 110, a first issuer server 112, and a second issuer server 114. The first through third devices 104a-104c, the merchant server 106, the acquirer server 108, the payment network server 110, and the first and second issuer servers 112 and 114 may communicate with each other by way of a communication network 116 or through separate communication networks established therebetween.

The first through third users 102a-102c are individuals associated with various payment modes. The first user 102a is associated with a first payment mode. In one example, the first payment mode may be a first transaction card. The first transaction card may be linked to a payment account of the first user 102a that is maintained at a financial institution, such as a first issuer. In another example, the first payment mode may be a first digital wallet maintained at a financial institution, for example the first issuer. Examples of the first digital wallet may include, but are not limited to, Apple Pay Cash®, or the like. In a non-limiting example, it is assumed that the first payment mode is the first transaction card. The second user 102b i s associated with a second payment mode. The second payment mode may be a second transaction card issued by the first issuer or a second digital wallet maintained at the first issuer. In a non-limiting example, it is assumed that the second payment mode is the second digital wallet. The third user 102c is associated with third and fourth payment modes. In one example, the third and fourth payment modes are third and fourth transaction cards, respectively, issued by the first issuer. In another example, the third and fourth payment modes are third and fourth digital wallets, respectively, maintained at the first issuer. For the sake of ongoing description, it is assumed that the third payment mode is the third transaction card and the fourth payment mode is the fourth digital wallet. It will be apparent to those of skill in the art that the first through fourth payment modes may be maintained at same or different issuers without deviating from the scope of the disclosure.

The first through third devices 104a-104c are communication devices of the first through third users 102a-102c, respectively. Examples of the first through third devices 104a-104c may include smartphones, personal computers, tablets, phablets, or the like. The first device 104a is used by the first user 102a to access various service applications, for example, first and second service applications 118 and 120. The first service application 118 may be a payment application that enables users (e.g., the first user 102a) to make payments for purchases. The second service application 120 may be an e-commerce application that enables users to make purchases for products and/or services from a first merchant. For example, the first service application 118 may enable the first user 102a to perform a first transaction for a purchase of a first product made by using the second service application 120. The first and second service applications 118 and 120 may be mobile applications or web applications that run or are executed on the first device 104a. Though the first and second service applications 118 and 120 are shown to be separate applications, in other embodiments, the functionality of the second service application 120 may be integrated into the first service application 118, without deviating from the scope of the disclosure. In such a scenario, the first service application 118 may present various products and/or services that are offered for sale by various merchants (e.g., the first merchant). The second and third devices 104b and 104c are functionally similar to the first device 104a.

The merchant server 106 is a computing server operated by the first merchant. The merchant server 106 may host the second service application 120. The second service application 120 is executable on various devices (such as the first through third devices 104a-104c), and may present, to users (such as the first through third users 102a-102c) on corresponding devices, a catalogue of products and/or services offered for sale by the first merchant. The second service application 120 may allow the users to purchase the products and/or services offered by the first merchant. In one embodiment, the second service application 120 may allow the use of the first service application 118 for making payments for the purchases that are made using the second service application 120.

The acquirer server 108 is a computer server operated by a first acquirer. The acquirer server 108 is a financial institution that maintains a payment account of the first merchant. In one example, the first acquirer may be same as the first issuer. In another example, the first acquirer may be different from the first issuer. The acquirer server 108 may credit or debit the payment account of the first merchant based on various transactions that are associated with the payment account of the first merchant.

The payment network server 110 is a computing server that is operated by a payment network. The payment network is an intermediate entity between acquirers (for example, an acquirer associated with the first merchant) and issuers for processing transactions. In one embodiment, the payment network server 110 executes operations for providing a transaction service by hosting the first service application 118. By hosting the first service application 118, the payment network server 110 allows users (such as the first user 102a) to join and/or create virtual groups, and add corresponding payment modes (e.g., the first payment mode) to the virtual groups. By hosting the first service application 118, the payment network server 110 further allows group members of each virtual group to perform transactions (e.g., purchase products and/or services from merchants) using payment modes of other group members of the corresponding virtual group. For example, the payment network server 110 may enable the first user 102a to make a purchase from the first merchant using any payment mode that is added to a virtual group that has the first user 102a as a group member.

The first issuer server 112 is a computing server that is operated by the first issuer. The first issuer may be a financial institution that manages payment accounts and digital wallets of multiple users (such as the first through third users 102a-102c). Account details of the user accounts established with the first issuer are stored as account profiles. The first issuer server 112 credits and debits the payment accounts or the digital wallets based on purchases made by the users from their corresponding payment accounts or digital wallets.

The second issuer server 114 is a computing server that is operated by a second issuer that may be different from the first issuer. The second issuer may be a financial institution that manages payment accounts of various payment networks (for example, the payment network associated with the payment network server 110).

The communication network 116 is a medium through which content and messages are transmitted between the first through third devices 104a-104c, the merchant server 106, the acquirer server 108, the payment network server 110, the first and second issuer servers 112 and 114, and other entities that are pursuant to one or more standards for the interchange of transaction messages, such as the ISO8583 standard. Examples of the communication network 116 include, but are not limited to, a Wi-Fi network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the environment 100 may connect to the communication network 116 in accordance with various wired and wireless communication protocols, such as Transmission Control Protocol and Internet Protocol (TCP/IP), User Datagram Protocol (UDP), Long Term Evolution (LTE) communication protocols, or any combination thereof.

In operation, the payment network server 110 may receive a group creation request from a device (e.g., the first device 104a) to create a first virtual group. The payment network server 110 may create the first virtual group based on the group creation request. Further, the payment network server 110 may add the first user 102a as a first group member of the first virtual group. The payment network server 110 may also add one or more other users (e.g., the second and third users 102b and 102c) to the first virtual group, who accept an invite from the first user 102a to join the first virtual group, as group members. Thus, the first virtual group may include the first through third users 102a-102c as first through third group members. The payment network server 110 may also add, to the first virtual group, the payment modes (e.g., the first through fourth payment modes of the first through third users 102a-102c) of the first through third group members. The first through fourth payment modes that are added to the first virtual group may be accessible to all group members of the first virtual group. The payment network server 110 may also maintain other virtual groups that are functionally similar to the first virtual group.

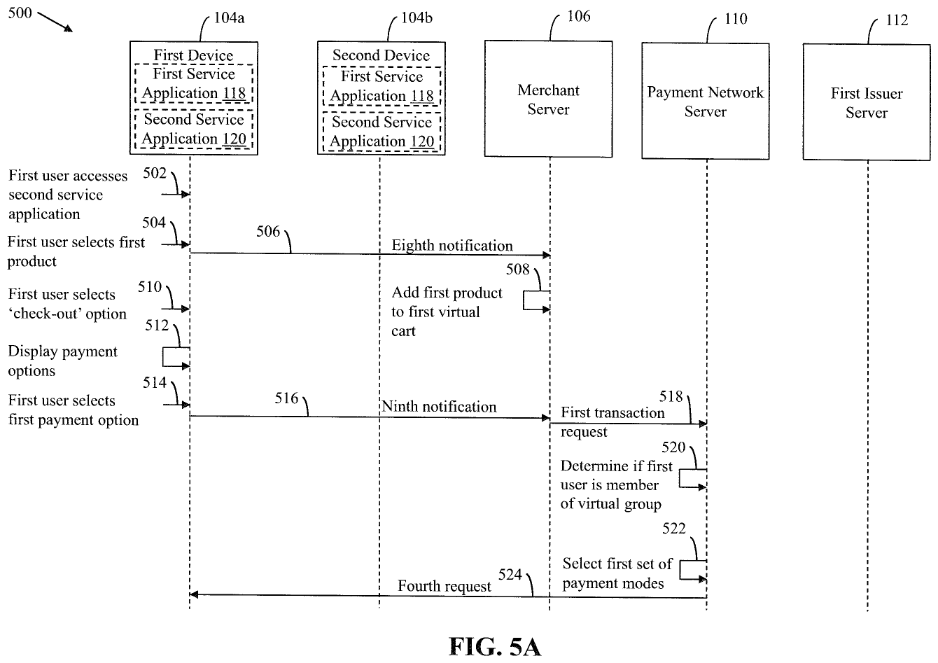

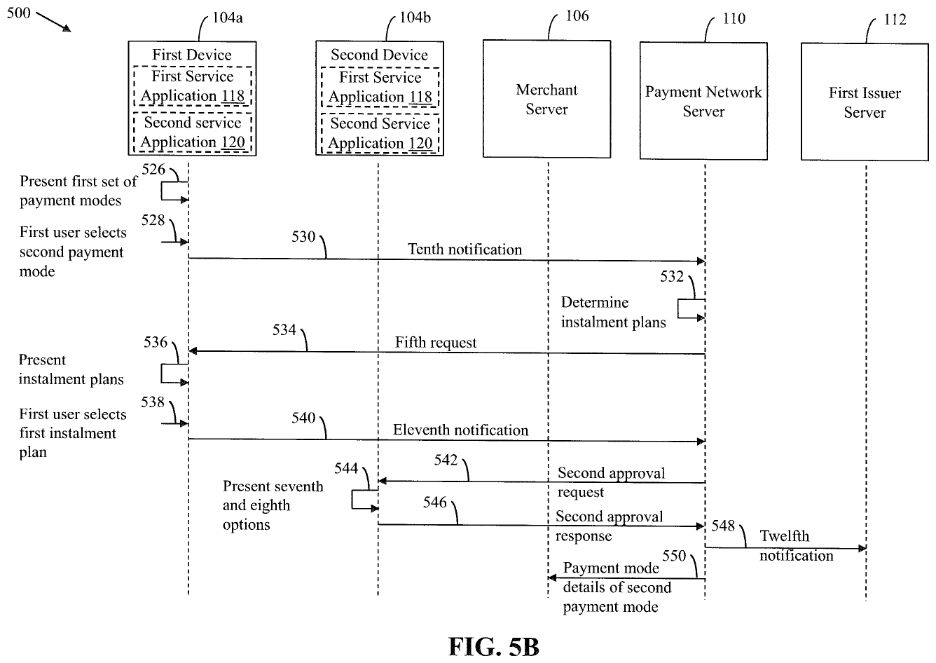

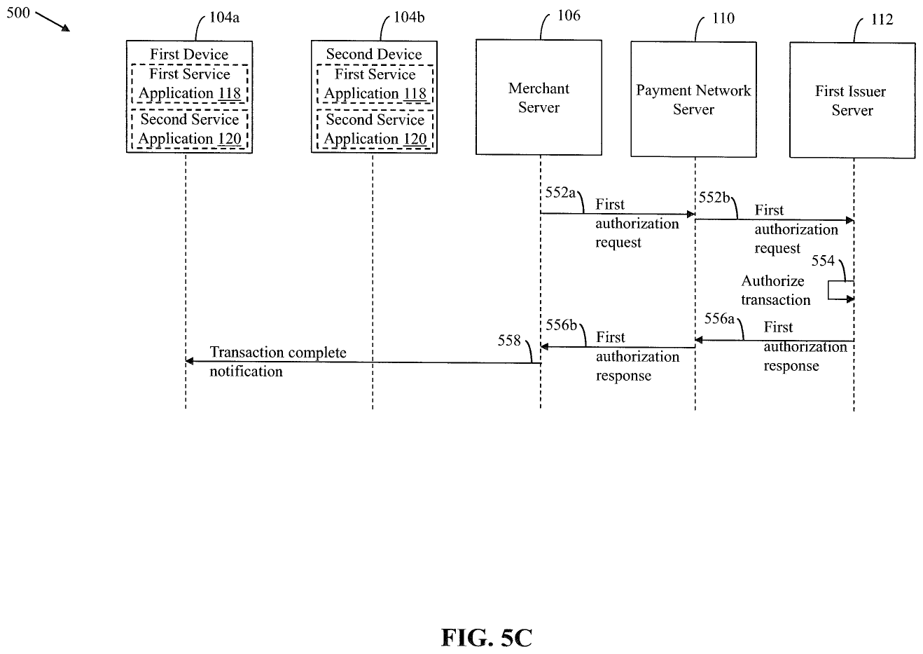

The first user 102a may access the second service application 120 that runs on the first device 104a for making a purchase and may attempt to perform a first transaction for the purchase by accessing the first service application 118. The payment network server 110 may receive a first transaction request for the first transaction. Based on the first transaction request, the payment network server 110 may identify that the first user 102a is a group member of the first virtual group. Thus, the payment network server 110 may select, from the first through fourth payment modes that are added to the first virtual group, a first set of payment modes that is most suitable for the first transaction. The payment network server 110 may, then, render a first graphical interface (i.e., user interface, UI) on a display of the first device 104a for presenting the first set of payment modes to the first user 102a, for selection. Further, the payment network server 110 may request the first user 102a to select, from the presented first set of payment modes, a payment mode for carrying out the first transaction. The first user 102a may select a payment mode (e.g., the second payment mode) from the first set of payment modes for carrying out the first transaction. As described in the foregoing, the second payment mode is associated with the second user 102b who is also a group member of the first virtual group. The payment network server 110 may communicate to the second user 102b, by way of the second device 104b, an approval request for requesting an approval for using the second payment mode to carry-out the first transaction. The second device 104b may generate and communicate an approval response to the payment network server 110, based on an approval provided by the second user 102b. Based on the approval response, the payment network server 110 initiates the first transaction using the second payment mode. After the first transaction is initiated and successfully executed using the second payment mode, the payment network server 110 may facilitate a settlement of a first transaction amount of the first transaction between the first and second users 102a and 102b. Operations performed by the payment network server 110 for facilitating the first transaction are explained in detail in conjunction with FIGS. 5A-5C, 6, 7A-7C, and 8.

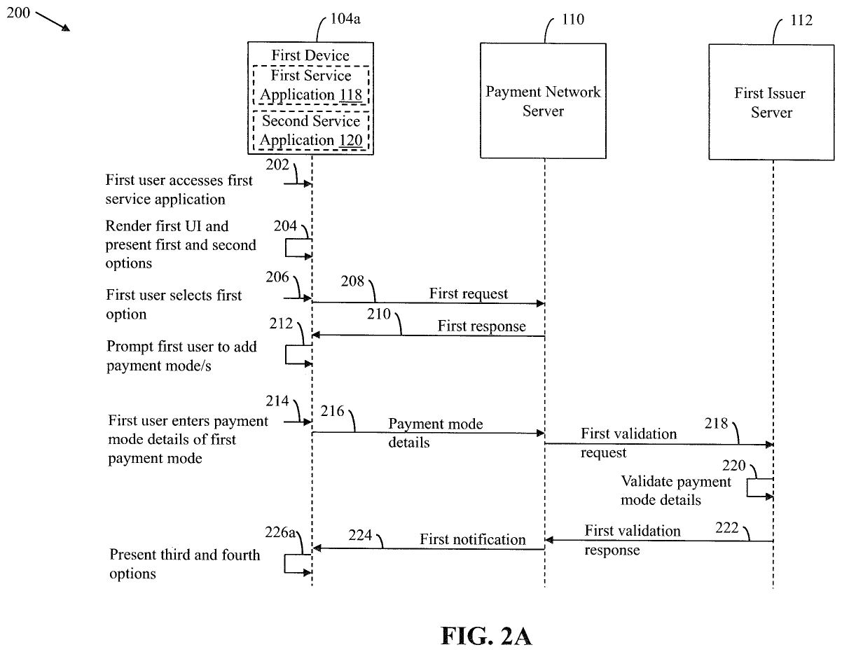

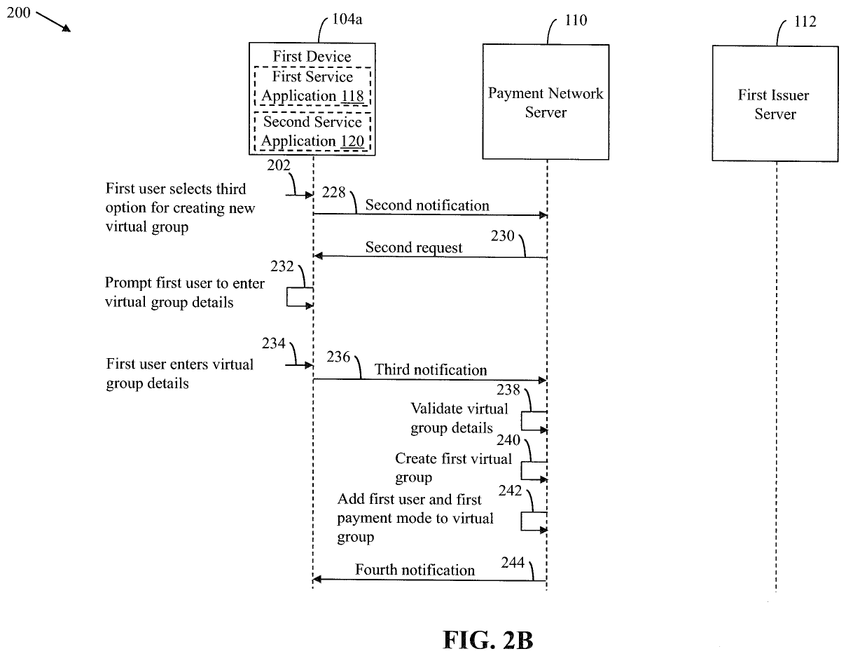

FIGS. 2A and 2B, collectively represent a process flow diagram 200 that illustrates an exemplary scenario for creating the first virtual group, in accordance with an exemplary embodiment of the present disclosure. For the sake of ongoing description of FIGS. 2A and 2B, it is assumed that the first user 102a utilizes the first device 104a executing the first service application for creating the first virtual group.

The first user 102a may utilize the first device 104a to access the first service application 118 that runs or is executed on the first device 104a (as shown by arrow 202). The payment network server 110 may render a first UI on the display of the first device 104a by way of the first service application 118. The first UI may present first and second options that allows the first user 102a to sign-up or login to the first service application 118, respectively (as shown by arrow 204). The first user 102a may select the first option if the first user 102a is a first-time user of the first service application 118. The first user 102a may select the second option if the first user 102a is an existing user of the first service application 118. If the first user 102a is an existing user of the first service application 118, the first user 102a may log into the first service application 118 using a username and a password of the first user 102a. In a non-limiting example, it is assumed that the first user 102a is a first-time user of the first service application 118 and selects the first option (as shown by arrow 206). Based on the selection of the first option, the first device 104a may communicate a first request to the payment network server 110 (as shown by arrow 208). The first request may be a request for signing up with the payment network server 110. The first user 102a may sign-up with the payment network server 110 for availing the transaction service offered by the payment network server 110.

Based on the first request, the payment network server 110 may communicate a first response to the first device 104a (as shown by arrow 210), instructing the first service application 118 to initiate a sign-up procedure for the first user 102a. Based on the first response, a message is displayed on the first UI, prompting the first user 102a to add one or more payment modes (as shown by arrow 212). The first user 102a may also be prompted to provide personal details (e.g., a name of the first user 102a, contact details of the first user 102a, or the like) of the first user 102a. The first user 102a may provide the personal details of the first user 102a and payment mode details of the first payment mode (as shown by arrow 214). Since the first payment mode is the first transaction card, the payment mode details of the first payment mode may include, but are not limited to, a first transaction card number of the first transaction card, a name of a cardholder (i.e., the name of the first user 102a) of the first transaction card, an expiry date of the first transaction card, or the like.

The first device 104a may communicate the personal details of the first user 102a and the payment mode details of the first payment mode to the payment network server 110 (as shown by arrow 216). The payment network server 110 may store the personal details of the first user 102a in a first user profile of the first user 102a. The first user profile may be stored in a memory of the payment network server 110. The payment network server 110 may communicate a first validation request to the first issuer server 112, requesting the first issuer to validate the payment mode details of the first payment mode (as shown by arrow 218). The first validation request may include the payment mode details of the first payment mode. The first issuer server 112 may validate the payment mode details of the first payment mode (as shown by arrow 220). For example, the first issuer server 112 may determine whether the name of the card holder, the first transaction card number, and the expiry date are correct. Methods of validation of the payment mode details will be known to those of skill in the art. Based on a result of the validation, the first issuer server 112 may generate and communicate a first validation response to the payment network server 110 (as shown by arrow 222). The first validation response may be indicative of a success or a failure of the validation of the payment mode details. In a non-limiting example, it is assumed that the first validation response indicates that the payment mode details of the first payment mode are valid. Based on the first validation response, the payment network server 110 may communicate a first notification to the first device 104a, indicating that the payment mode details of the first payment mode are valid (as shown by arrow 224). Based on the first notification, third and fourth options are presented on the first UI for allowing the first user 102a to create a new virtual group or join an existing virtual group of an acquaintance, respectively (as shown by arrow 226a).

With reference to FIG. 2B, in a non-limiting example, it is assumed that the first user 102a selects the third option (i.e., a group creation request option) for creating a new virtual group (as shown by arrow 226b). Based on the selection of the third option, the first device 104a may communicate a second notification to the payment network server 110 (as shown by arrow 228). The second notification may indicate the selection of the third option by the first user 102a. Based on the second notification, the payment network server 110 may communicate a second request to the first device 104a for requesting the first user 102a to enter virtual group details of the first virtual group for creating the first virtual group (as shown by arrow 230). Based on the second request, the first device 104a may prompt the first user 102a to enter the virtual group details of the first virtual group (as shown by arrow 232). The virtual group details may include, but not be limited to, a first group identifier (ID) of the first virtual group, a first group alias (i.e., a first group name) of the first virtual group, a first set of rules for the first virtual group, or the like.

Examples of the first set of rules may include, but are not limited to, type of payment modes that may be added to the first virtual group, association of group members with one or more organizations, a minimum amount of balance to be maintained in an added payment mode, or the like. In one embodiment, a first rule may allow only transaction card holders to join the first virtual group. A second rule may allow only users associated with specific categories of payment modes (i.e., specific categories of transaction cards or specific categories of digital wallets) to join the first virtual group. For example, the second rule may allow only users associated with premium transaction cards or premium digital wallets to join the first virtual group. A third rule may allow only users employed with a particular organization to join the first virtual group. It will be apparent to those of skill in the art that the first set of rules may pertain to any matter and should not be construed to limit the scope of the disclosure in any manner. The first set of rules may allow the first user 102a to restrict access of other users to the first virtual group. In a non-limiting example, it is assumed that the first set of rules allow entry to only those invited users whose credit limits are greater than a threshold amount. For example, the first set of rules may allow entry to only those invited users whose credit limits are greater than ‘$700’. The first user 102a may enter the virtual group details of the first virtual group (as shown by arrow 234). Based on the virtual group details entered by the first user 102a, the first device 104a may communicate a third notification to the payment network server 110 (as shown by arrow 236). The third notification may include the virtual group details of the first virtual group, as entered by the first user 102a.

The payment network server 110 may validate the received virtual group details (as shown by arrow 238). For example, the payment network server 110 may determine if the first group ID is unique and is not assigned to any existing virtual group. In another embodiment, the payment network server 110 may recommend an alternative unique group ID if the first group ID entered by the first user 102a is not unique. If the virtual group details of the first virtual group are determined to be valid, the payment network server 110 may create the first virtual group (as shown by arrow 240). On successful creation of the first virtual group, the payment network server 110 may add the first user 102a and the first payment mode of the first user 102a to the first virtual group (as shown by arrow 242). Thus, the first user 102a is now a first group member of the first group. The payment network server 110 may designate the first user 102a as a first group administrator (admin) of the first virtual group. The payment network server 110 may communicate a fourth notification to the first device 104a, indicating that the first user 102a is added to the first virtual group (as shown by arrow 244). The fourth notification may also indicate that the first payment mode is added to the first virtual group and that the first user 102a is designated as the first group admin of the first virtual group. It will be apparent to those of skill in the art that the first user 102a may add multiple payment modes to the first virtual group without deviating from the scope of the disclosure.

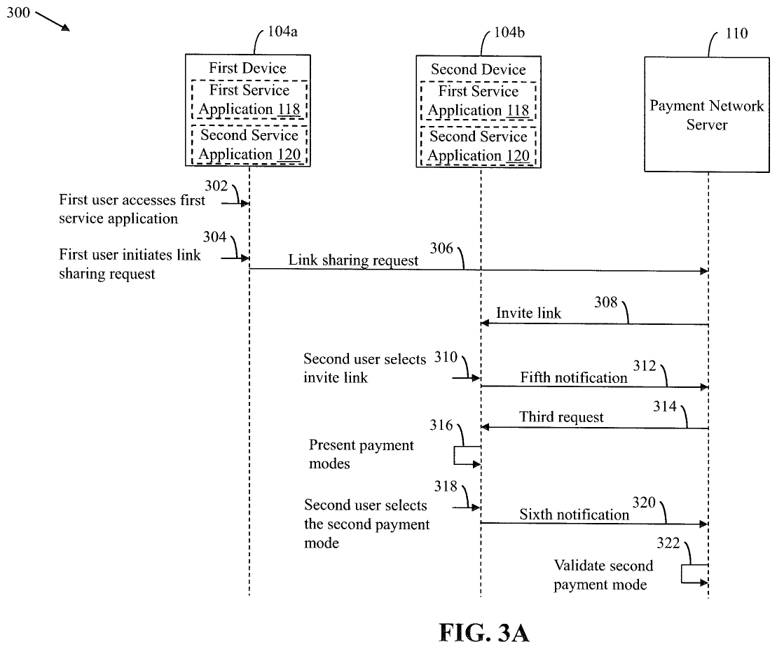

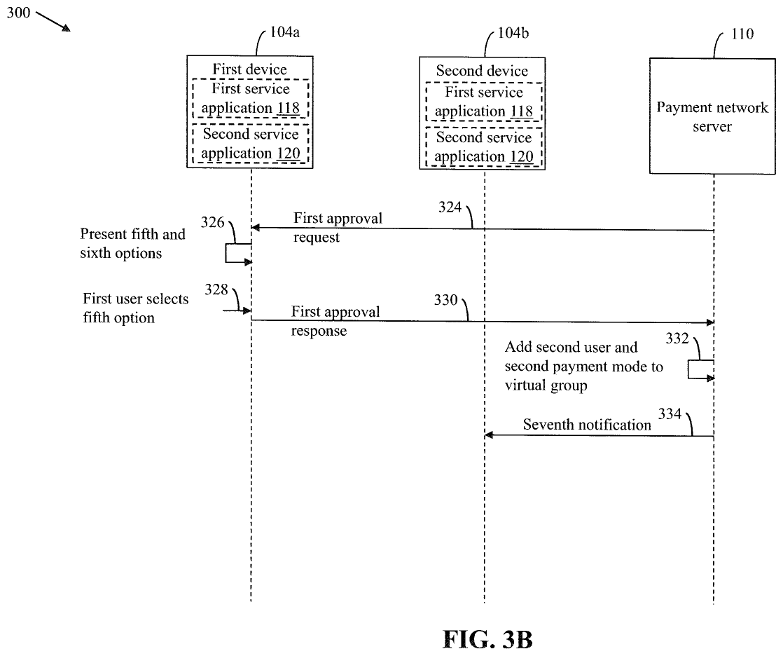

FIGS. 3A and 3B, collectively represent a process flow diagram 300 that illustrates an exemplary scenario for adding group members to the first virtual group, in accordance with an exemplary embodiment of the present disclosure.

As the first group admin, the first user 102a may be authorized to invite other users (e.g., the second user 102b) to join the first virtual group. It will be apparent to those of skill in the art that, in other embodiments, other group members or admins of the first virtual group may also be authorized to invite users to join the first virtual group. The first user 102a may utilize the first device 104a to access the first service application 118 that runs or is executed on the first device 104a (as shown by arrow 302), and may initiate a link sharing request by way of the first service application 118 (as shown by arrow 304). The first user 102a may initiate the link sharing request for inviting the second user 102b to join the first virtual group as a group member. The first user 102a may provide contact details (e.g., a phone number, a profile ID of a social media account, a profile ID of an instant messaging account, and/or the like) of the second user 102b for initiating the link sharing request. The first device 104a may communicate the link sharing request to the payment network server 110 (as shown by arrow 306). Based on the link sharing request, the payment network server 110 may communicate a first invite link to the second device 104b of the second user 102b (as shown by arrow 308). The first invite link corresponds to an invitation communicated to the second user 102b by the payment network server 110 on behalf of the first user 102a, for requesting the second user 102b to join the first virtual group. The first invite link may be shared with the second device 104b as an e-mail, a text message, an instant message, an in-app notification on the first service application 118, or the like. Methods of sharing the first invite link will be known to those of skill in the art.

The second device 104b may receive the first invite link and the second user 102b may access the first service application 118 by selecting the first invite link (as shown by arrow 310). In other words, the second device 104b may re-direct the second user 102b to the first service application 118 when the second user 102b selects or activates the first invite link. The selection or the activation of the first invite link by the second user 102b constitutes an acceptance of the invitation to join the first virtual group by the second user 102b. When the second user 102b selects the first invite link, the second device 104b may communicate a fifth notification to the payment network server 110 (as shown by arrow 312). The fifth notification is indicative of the selection or the activation of the first invite link by the second user 102b. The second user 102b may be a new user or an existing user of the first service application 118. In non-limiting example, it is assumed that the second user 102b is an existing user of the first service application 118 and logs into the first service application 118, using a username and password of the second user 102b.

Based on the fifth notification, the payment network server 110 may communicate a third request to the second device 104b (as shown by arrow 314), requesting the second user 102b to add corresponding payment modes to the first virtual group. Since the second user 102b is an existing user of the first service application 118, the payment network server 110 may have already stored personal details of the second user 102b and payment mode details of the second payment mode in a second user profile of the second user 102b. In other words, the second user 102b may have already registered the second payment mode with the payment network server 110. In such a scenario, the request may include payment mode details of the payment modes registered by the second user 102b with the payment network server 110. Based on the third request, the first UI of the first service application 118 is rendered on the second device 104b to present the registered payment modes (e.g., the second payment mode) to the second user 102b for selection (as shown by arrow 316). The first UI may also present an option to the second user 102b to add a new payment mode. In a non-limiting example, it is assumed that the second user 102b selects the second payment mode that is already registered for adding to the first virtual group (as shown by arrow 318). Based on the selection of the second payment mode, the second device 104b may communicate a sixth notification to the payment network server 110 (as shown by arrow 320). The sixth notification may be indicative of the selection of the second payment mode by the second user 102b.

Based on the sixth notification, the payment network server 110 may validate the payment mode details of the second payment mode to ensure conformity with the first set of rules associated with the first virtual group (as shown by arrow 322). For example, according to one of the first set of rules associated with the first virtual group, only those payment modes that have credit limits greater than ‘$700’ may be added to the first virtual group. Thus, the payment network server 110 may determine whether a credit limit of the second payment mode is greater than ‘$700’. In a non-limiting example, it is assumed that the credit limit of the second payment mode is greater than ‘$700’, and hence the payment network server 110 determines that the second payment mode is eligible for being added to the first virtual group. In one embodiment, the first virtual group may be a closed virtual group and an approval from the first group admin may be required before adding any new group member. Thus, on successful validation of the second payment mode, the payment network server 110 may communicate a first approval request to the first device 104a, requesting the first user 102a (i.e., the group admin) to approve the second user 102b to join the first virtual group (as shown by arrow 324). Based on the first approval request, the first device 104a executing the first service application 118 may present fifth and sixth options on the first UI (as shown by arrow 326). The fifth and sixth options may allow the first user 102a (i.e., the first group admin) to approve or decline the joining of the second user 102b, respectively. In a non-limiting example, it is assumed that the first user 102a selects the fifth option to approve the second user 102b to join the first virtual group (as shown by arrow 328).

Based on the selection of the fifth option, the first device 104a may communicate a first approval response to the payment network server 110 (as shown by arrow 330). The first approval response may indicate that the first user 102a has approved the second user 102b to join the first virtual group. Based on the first approval response, the payment network server 110 adds the second user 102b and the second payment mode of the second user 102b to the first virtual group (as shown by arrow 332). The payment network server 110 may also communicate a seventh notification to the second device 104b (as shown by arrow 334). The seventh notification may be indicative of the addition of the second user 102b and the second payment mode to the first virtual group. The seventh notification may also indicate that the second user 102b is now a group member of the first virtual group and may avail the transaction service offered by the payment network server 110.

In another embodiment, the second user 102b may be a new user of the first service application 118. In such a scenario, the second user 102b may sign-up with the payment network server 110 for availing the transaction service offered by the payment network server 110 as described for the first user 102a in the foregoing description of FIG. 2A.

It will be apparent to those of skill in the art that the third user 102c and the third and fourth payment modes of the third user 102c may be added to the first virtual group in a similar manner as described for the second user 102b. Thus, the second and third users 102b and 102c become second and third group members of the first virtual group, respectively. It will be apparent to those of skill in the art that one user may be a group member of multiple virtual groups, without deviating from the scope of the disclosure. In another embodiment, users may manually search for virtual groups by using the first service application 118 and may request to join the virtual groups. Such users may only be added to the virtual groups based on an approval from group admins of the corresponding virtual groups.

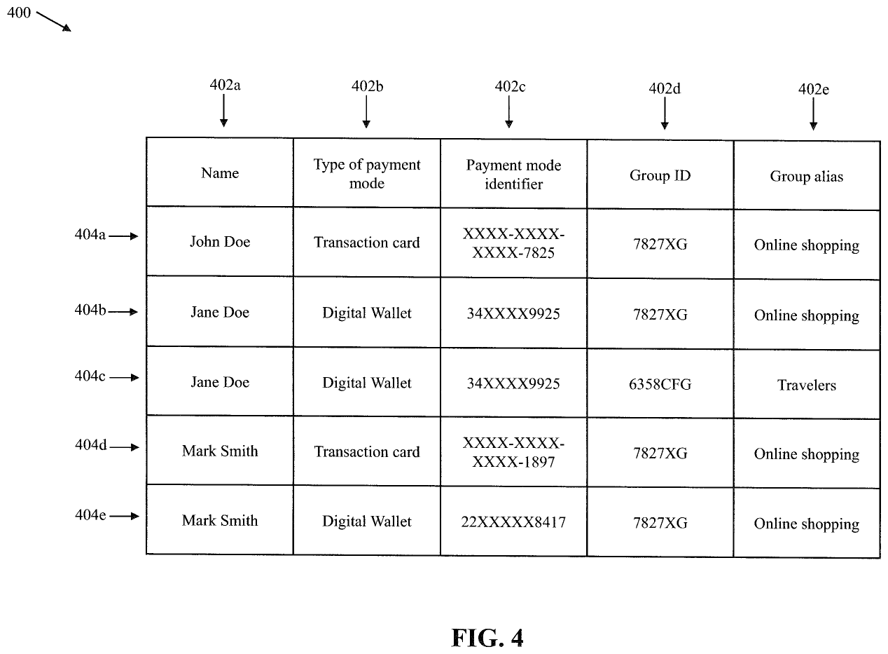

FIG. 4 is a Table 400 that illustrates details of virtual groups stored in a database maintained at the payment network server 110, in accordance with an exemplary embodiment of the disclosure. Table 400 includes columns 402a-402e and rows 404a-404e. The columns 402a-402e, respectively, indicate various parameters associated with the virtual groups such as a name (e.g., a username) of a group member of a virtual group, a type of payment mode added by the corresponding group member to the corresponding virtual group, a payment mode ID of the corresponding payment mode, a group ID of the corresponding virtual group, and a group alias of the corresponding virtual group. The information in Table 400 may be stored in an encrypted format to ensure data security to all group members.

The row 404a indicates that the first user 102a (i.e., ‘John Doe’) is a group member of the first virtual group having ‘7827XG’ as the first group ID and ‘Online shopping’ as the first group alias. The row 404a further indicates that the first payment mode is a transaction card having a transaction card number ‘XXXX-XXXX-XXXX-7825’ (i.e., a payment mode ID). The row 404b indicates that the second user 102b (i.e., Jane Doe') is a group member of the first virtual group having ‘7827XG’ as the first group ID and ‘Online shopping’ as the first group alias. The row 404b further indicates that the second payment mode is a digital wallet having a digital wallet ID ‘34XXXX9925’ (i.e., a payment mode ID).

The row 404c indicates that the second user 102b (i.e., ‘Jane Doe’) is a group member of a second virtual group having ‘6358CFGG’ as a second group ID and ‘Travelers’ as a second group alias. The row 404c further indicates that the second payment mode is the digital wallet having the digital wallet ID ‘34XXXX9925’. The rows 404b and 404c indicate that the second user 102b is a group member of two virtual groups (i.e., the first and second virtual groups). It will be apparent to those of skill in the art that a user (e.g., the second user 102b) may be a group member of any number of groups without deviating from the scope of the disclosure.

The row 404d indicates that the third user 102c (i.e., ‘Mark Smith’) is a group member of the first virtual group having ‘7827XG’ as the first group ID and ‘Online shopping’ as the first group alias. The row 404d further indicates that the third payment mode is a transaction card having a transaction card number ‘XXXX-XXXX-XXXX-1897’. The row 404e indicates that the third user 102c (i.e., ‘Mark Smith’) is a group member of the first virtual group having ‘7827XG’ as the first group ID and ‘Online shopping’ as the first group alias. The row 404e further indicates that the fourth payment mode is a digital wallet having a digital wallet ID ‘22XXXXX8417’. Table 400 further illustrates the third user 102c has added more than one payment modes to the first virtual group.

The information illustrated by Table 400 is merely exemplary and not meant to limit the scope of the disclosure. It will be apparent to those of skill in the art that Table 400 may also include information such as rules pertaining to each virtual group, parameters (e.g., credit limits, operating locations, or the like) of payment modes, or the like.

FIGS. 5A-5C, collectively represent a process flow diagram 500 that illustrates an exemplary scenario for facilitating a transaction, in accordance with an exemplary embodiment of the present disclosure. For the sake of brevity, the first through third users 102a-102c are referred to and designated as the first through third group members 102a-102c, respectively. The first through third users 102a-102c have been interchangeably referred to as the first through third group members 102a-102c.

The first group member 102a may utilize the first device 104a to access the second service application 120 that runs or is executed on the first device 104a (as shown by arrow 502). A second UI of the second service application 120 is rendered on a display of the first device 104a. The second UI may display a catalogue of products and/or services offered for sale by the first merchant. The first group member 102a may select, from the catalogue, a first product (e.g., a mobile phone) for purchasing (as shown by arrow 504). The first device 104a may communicate an eighth notification to the merchant server 106 (as shown by arrow 506), indicating the selection of the first product by the first group member 102a for purchase. Based on the eighth notification, the merchant server 106 may add the first product to a first virtual cart of the first group member 102a (as shown by arrow 508). The first virtual cart may be maintained at the merchant server 106 and may store a list of products and/or services selected by the first group member 102a for purchase.

The first group member 102a may select a ‘check-out’ option displayed on the second UI for purchasing the first product (as shown by arrow 510). Based on the selection of the ‘check-out’ option, the second service application 120 may display various payment options that may be used to make a payment for the purchase (as shown by arrow 512). The displayed payment options may include a first payment option that allows the first group member 102a to pay for the first product by using the first service application 118. It will be apparent to a person of skill in the art that the displayed payment options may also include other options that allow the first group member 102a to pay for the first product by using transaction cards, netbanking, digital wallets, loyalty points, or the like.

The first group member 102a may select the first payment option to pay for the first product (as shown by arrow 514). Based on the selection of the first payment option, control may be re-directed from the second service application 120 to the first service application 118, and the first UI of the first service application 118 may be rendered on the display of the first device 104a. The first device 104a may communicate a ninth notification to the merchant server 106 indicating the selection of the first payment option (as shown by arrow 516). Based on the ninth notification, the merchant server 106 may communicate a first transaction request to the payment network server 110 (as shown by arrow 518). The first transaction request may include details of the first group member 102a and transaction details of a first transaction that is associated with the first group member 102a and corresponds to the purchase of the first product. The transaction details may include a first transaction amount of the first transaction (i.e., a price of the mobile phone), a product category (for example, ‘Electronics’) of the first product, a merchant identifier of the first merchant, a transaction reference number of the first transaction, details of an offer available on the first transaction, and/or the like. The details of the first group member 102a may include a registered contact number of the first group member 102a, a registered username of the first group member 102a, or the like.

Based on the first transaction request, the payment network server 110 may determine whether the first group member 102a is a group member of any virtual group maintained at the payment network server 110 (as shown by arrow 520). For example, the payment network server 110 may refer to Table 400 to determine if the registered username of the first group member 102a is stored therein. In a scenario where the registered username of the first group member 102a is stored in Table 400, the payment network server 110 determines that the first group member 102a is a legitimate group member. In the current scenario, the payment network server 110 may determine that the first group member 102a is a group member of the first virtual group. The payment network server 110 may, then, select, from the payment modes that are added to the first virtual group, a first set of payment modes that are most suitable for the first transaction (as shown by arrow 522). The selection of the first set of payment modes may be based on various parameters such as, but not limited to, the first transaction amount, the product category, a credit limit of each payment mode added to the first virtual group, an eligibility of each payment mode to avail one or more benefits on the first transaction, or the like. For example, in one embodiment, the first set of payment modes may be selected such that a credit limit of each of the first set of payment modes is greater than or equal to the first transaction amount. In another embodiment, the first set of payment modes may be selected such that each of the first set of payment modes is eligible for availing the offer (e.g., a cashback offer, a discount offer, a reward points offer, or the like) on the first transaction. The payment network server 110 may select the first set of payment modes using a combination of such parameters. The payment network server 110 may use various algorithms (e.g., machine learning algorithms or artificial intelligence algorithms) to select the first set of payment modes. In a non-limiting example, it is assumed that the first set of payment modes is selected such that a credit limit of each of the first set of payment modes is greater than or equal to the first transaction amount. In one exemplary scenario, the credit limit of the first payment mode of the first group member 102a may be less than the first transaction amount, and the credit limits of the second through fourth payment modes may be greater than the first transaction amount. Hence, the first set of payment modes includes the second through fourth payment modes and does not include the first payment mode.

On selection of the first set of payment modes (i.e., the second through fourth payment modes), the payment network server 110 may communicate a fourth request to the first device 104a (as shown by arrow 524). The payment network server 110 may communicate the fourth request to request the first group member 102a to select a payment mode from the first set of payment modes for initiating the first transaction. The fourth request may be indicative of the first set of payment modes.

With reference to FIG. 5B, based on the fourth request, the first device 104a executing the first service application 118 may present the first set of payment modes on the first UI (as shown by arrow 526). The first group member 102a may select any payment mode from the first set of payment modes for carrying out the first transaction. In one exemplary scenario, the first group member 102a selects the second payment mode of the second group member 102b for initiating the first transaction (as shown by arrow 528).

Based on the selection of the second payment mode, the first device 104a may communicate a tenth notification to the payment network server 110 (as shown by arrow 530). The tenth notification may indicate the selection of the second payment mode by the first group member 102a. In one embodiment, the payment network server 110 may offer the first group member 102a an option to pay the first transaction amount to the second group member 102b, associated with the selected second payment mode, in instalments, when the first transaction amount is not covered by the first payment mode. In the current exemplary scenario, the credit limit of the first payment mode is less than the first transaction amount, thus, the payment network server 110 offers the first group member 102a the option to pay the first transaction amount to the second group member 102b in instalments (i.e., Easy monthly instalments, EMIs). The payment network server 110 may determine a first set of instalment plans based on various factors (as shown by arrow 532). The factors may include, but are not limited to, the first transaction amount, a credit score of the first group member 102a, a rate of interest applicable on each instalment plan, or the like. The payment network server 110 may communicate a fifth request to the first device 104a (as shown by arrow 534). The fifth request may be indicative of the first set of instalment plans determined by the payment network server 110.

Based on the fifth request, the first device 104a executing the first service application 118 may display the first set of instalment plans on the first UI for selection by the first group member 102a (as shown by arrow 536). The first group member 102a may select any instalment plan from the displayed first set of instalment plans. In one example, the first group member 102a selects the first instalment plan (as shown by arrow 538). In one exemplary scenario, the first transaction amount may be equal to ‘$1,000’ and the first instalment plan may allow the first group member 102a to settle the first transaction in ‘11’ months at a rate of interest equal to ‘10%’. Thus, the first group member 102a may be liable to pay a total amount of ‘$1,100’ ($1,100=$1,000+$1,000*10/100) in monthly instalments of ‘$100’ ($100=$1,100/11) to the second group member 102b over a period of ‘11’ months. In one embodiment, the payment network server 110 may charge the first group member 102a a first fee for availing the transaction service. In such a scenario, the first group member 102a may be liable to pay the first fee, in addition to the monthly instalments.

Based on the selection of the first instalment plan, the first device 104a may communicate an eleventh notification to the payment network server 110 (as shown by arrow 540). The eleventh notification may be indicative of the selection of the first instalment plan. The payment network server 110 may then communicate a second approval request to the second group member 102b for requesting an approval to use the second payment mode for initiating the first transaction (as shown by arrow 542). The second approval request may be indicative of the transaction details of the first transaction and the details of the first instalment plan. Thus, the second approval request may indicate that the first group member 102a may repay the second group member 102b in instalments of ‘$100’ over a period of ‘11’ months. Based on the second approval request, the second device 104b executing the first service application 118 may present seventh and eighth options to the second group member 102b (as shown by arrow 544). The seventh option is for approving the use of the second payment mode and the eighth option is for declining the use of the second payment mode, for initiating the first transaction. In a non-limiting example, it is assumed that the second group member 102b selects the seventh option and approves the use of the second payment mode for initiating the first transaction. In another embodiment, if the second group member 102b selects the eighth option and declines the use of the second payment mode for carrying out the first transaction, the payment network server 110 may communicate a notification to the first device 104a, indicating that the second group member 102b has declined the use of the second payment mode and may request the first group member 102a to select another payment mode from the first set of payment modes. In one exemplary scenario, the payment network server 110 may offer the second group member 102b a reward amount for approving the use of the second payment mode for carrying out the first transaction. In such a scenario, the first group member 102a may be liable to pay the reward amount to the payment network server 110, in addition to the monthly instalments.

Based on the selection of the seventh option by the second group member 102b, the second device 104b may communicate a second approval response to the payment network server 110 (as shown by arrow 546). The second approval response may indicate the approval of the second group member 102b for initiating the first transaction using the second payment mode. The payment network server 110 may also communicate a twelfth notification to the first issuer server 112 (as shown by arrow 548). The twelfth notification may include the transaction details of the first transaction and information pertaining to the first instalment plan selected by the first group member 102a. For initiating the transaction by way of the second payment mode, the payment network server 110 may communicate payment mode details of the second payment mode to the merchant server 106, requesting the first merchant to use the second payment mode for the first transaction (as shown by arrow 550). The merchant server 106 may generate a first authorization request for authorization of the first transaction initiated using the second payment mode.

With reference to FIG. 5C, the merchant server 106 may then communicate the first authorization request to the first issuer server 112 by way of the payment network server 110 (as shown by arrows 552a and 552b). In a scenario where the second payment mode is maintained at another issuer server (not shown) that is different from the first issuer server 112, the merchant server 106 may communicate the first authorization request to the other issuer server by way of the payment network server 110, without deviating from the scope of the disclosure.

The first issuer server 112 may authorize the first transaction based on the first authorization request (as shown by arrow 554) and may deduct an amount equal to the first transaction amount from the second payment mode (i.e., the second digital wallet). The first issuer server 112 may communicate a first authorization response to the merchant server 106 by way of the payment network server 110, indicating that the first transaction is authorized (as shown by arrows 556a and 556b). Based on the first authorization response, the merchant server 106 may communicate a transaction complete notification to the first device 104a for notifying the first group member 102a that the first transaction is complete and the first product is successfully purchased by the first group member 102a (as shown by arrow 558).

In another embodiment, the payment network server 110 may not offer the option to the first group member 102a to pay the first transaction amount to the second group member 102b in instalments, and may request the first group member 102a to specify a first time period within which the first group member 102a is ready to pay the first transaction amount to the second group member 102b. In such a scenario, the second approval request includes the information pertaining to the first time period instead of the information pertaining to the selected instalment plan.

In another embodiment, the payment network server 110 may not offer the option to the first group member 102a to pay the first transaction amount to the second group member 102b in instalments and may allow the first group member 102a to use the second payment mode of the second group member 102b for keeping the first product on hold for a second time period. Based on an approval of the second group member 102b, the payment network server 110 may request the first issuer server 112 to block an amount equal to the first transaction amount from the second payment mode, and may also request the merchant server 106 to keep the first product on hold for the second time period. When the first group member 102a pays the first transaction amount to the second group member 102b within the second time period, the payment network server 110 may request the first issuer server 112 to deduct the blocked amount from the second payment mode. However, if the first group member 102a fails to pay the first transaction amount to the second group member 102b within the second time period, the blocked amount is released for use to the second group member 102b and the hold on the first product is also released.

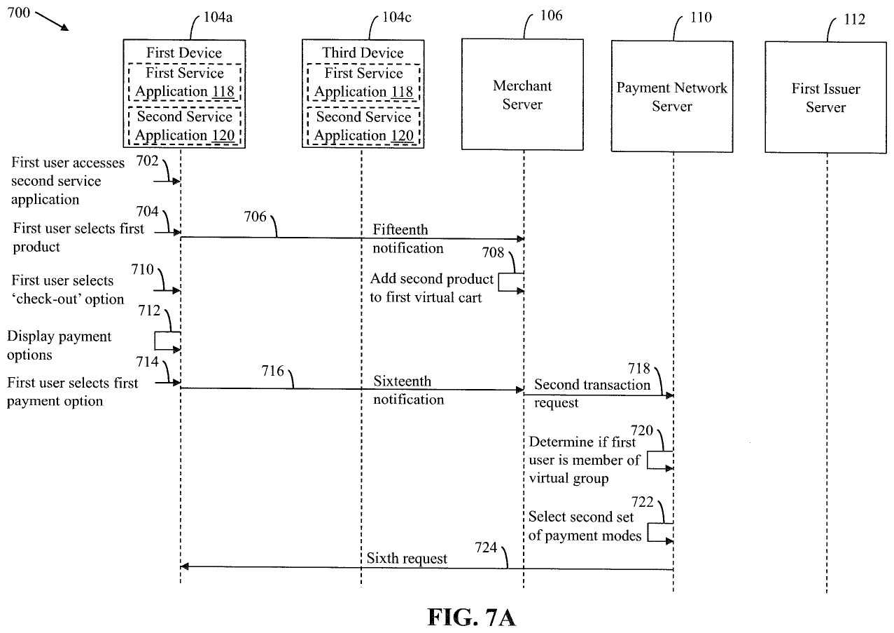

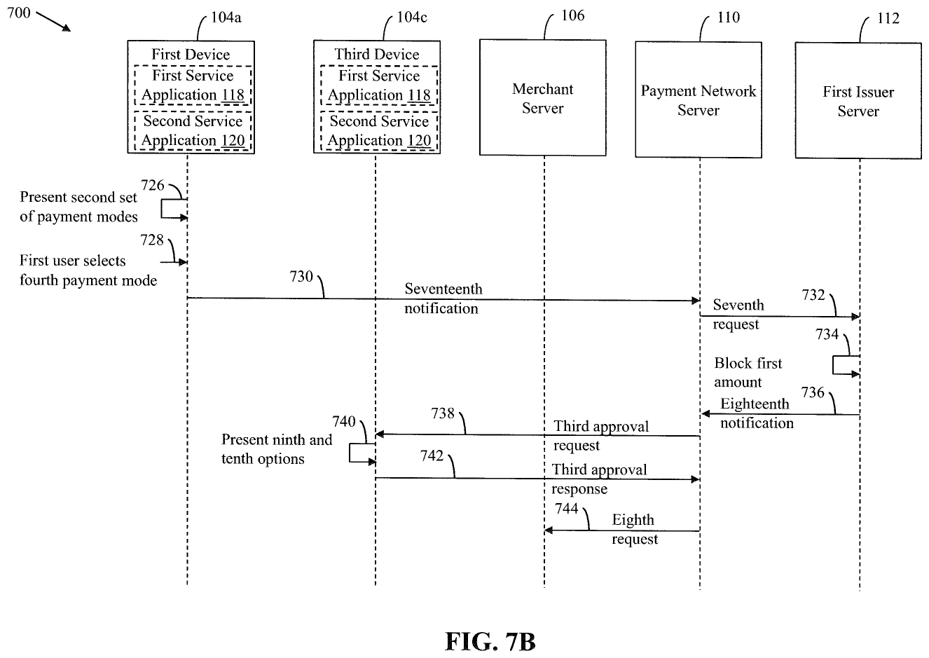

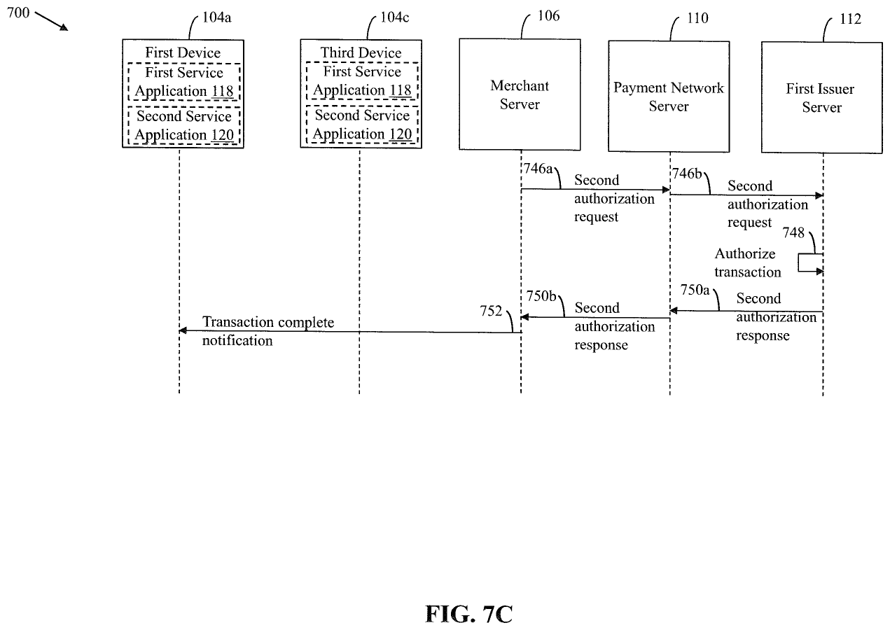

In another embodiment, the payment network server 110 may not offer the option to the first group member 102a to pay the first transaction amount to the second group member 102b in instalments and may block an amount equal to the first transaction amount from the first payment mode of the first group member 102a. After blocking the first transaction amount from the first payment mode, the payment network server 110 may directly communicate the second approval request to the second group member 102b for requesting the approval from the second group member 102b to use the second payment mode for initiating the first transaction. An exemplary scenario where the payment network server 110 blocks a transaction amount from the first payment mode of the first group member 102a is described in detail in conjunction with FIGS. 7A-7C.

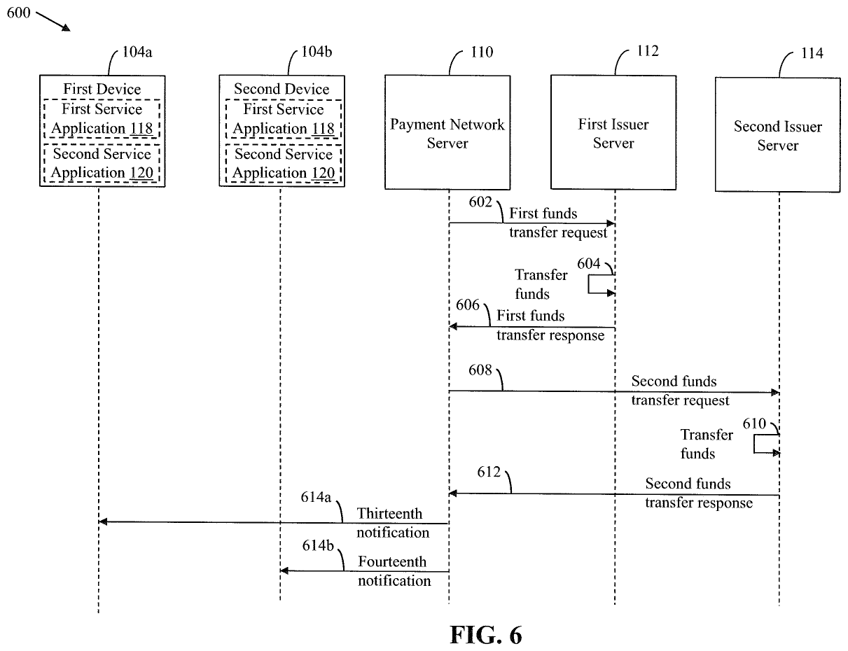

FIG. 6 represents a process flow diagram 600 that illustrates an exemplary scenario for settling the first transaction amount of the first transaction, in accordance with an exemplary embodiment of the disclosure. FIG. 6 is explained in conjunction with FIGS. 1-4 and 5A-5C. The payment network server 110 may facilitate settlement of the first transaction amount between the first and second group members 102a and 102b, based on the initiation and successful execution of the first transaction.

For the settlement of the first transaction amount, the payment network server 110 may communicate a first funds transfer request to the first issuer server 112 for transferring an amount (i.e., ‘$100’) as a monthly instalment to a payment account of the payment network that is maintained at the second issuer server 114 (as shown by arrow 602). The first funds transfer request may be indicative of the monthly instalment amount and an ID of the payment account of the payment network. Based on the first funds transfer request, the first issuer server 112 may transfer the amount equal to the monthly instalment from the payment account that is linked to the first payment mode of the first group member 102a to the payment account of the payment network (as shown by arrow 604). When the funds transfer is successful, the first issuer server 112 may communicate a first funds transfer response to the payment network server 110 (as shown by arrow 606). The first funds transfer response may indicate a successful transfer of the amount equal to the monthly instalment to the payment account of the payment network. Based on the first funds transfer response, the payment network server 110 may communicate a second funds transfer request to the second issuer server 114 for transferring an amount equal to monthly instalment amount from the payment account of the payment network to the second digital wallet (i.e., the second payment mode) of the second group member 102b (as show by arrow 608). The second funds transfer request may be indicative of the monthly instalment amount and the payment ID of the second payment mode (e.g., the digital wallet ID of the second digital wallet). Based on the second funds transfer request, the second issuer server 114 may transfer the amount equal to the monthly instalment from the payment account of the payment network to the second digital wallet (as shown by arrow 610). When the funds transfer is successful, the second issuer server 114 may communicate a second funds transfer response to the payment network server 110 (as shown by arrow 612). The second funds transfer response may indicate a successful transfer of the amount equal to the monthly instalment to the second digital wallet. On receiving the first funds transfer response, the payment network server 110 may communicate thirteenth and fourteenth notifications to the first and second devices 104a and 104b, respectively (as shown by arrows 614a and 614b). Based on the thirteenth notification, the first device 104a may present a message to the first group member 102a, indicating that the monthly instalment is successfully transferred to the second digital wallet of the second group member 102b. Based on the fourteenth notification, the second device 104b may present a message to the second group member 102b, indicating that the monthly instalment is successfully transferred to the second digital wallet. The payment network server 110 may periodically (e.g., monthly) communicate funds transfer requests to the first issuer server 112 to transfer the monthly instalments to the second digital wallet until an entirety of ‘$1,100’ is transferred to the second digital wallet.

In another embodiment, when the first group member 102a has not opted for instalment and has specified the first time period for paying the first transaction amount to the second group member 102b, the payment network server 110 may communicate periodic reminders to the first device 104a. The periodic reminders may include a message indicating a remaining time period within which the first transaction amount is to be paid to the second group member 102b.

FIGS. 7A-7C, collectively represent a process flow diagram 700 that illustrates an exemplary scenario for facilitating a transaction, in accordance with another exemplary embodiment of the disclosure. For the sake of brevity, the first through third users 102a-102c are referred to and designated as the first through third group members 102a-102c, respectively.

The first group member 102a may utilize the first device 104a to access the second service application 120 that runs or is executed on the first device 104a (as shown by arrow 702). The second UI of the second service application 120 is rendered on the display of the first device 104a. The second UI may present the catalogue of products and/or services offered for sale by the first merchant. The first group member 102a may select, from the catalogue, a second product (e.g., a piece of jewelry) for purchasing (as shown by arrow 704). The first device 104a may communicate a fifteenth notification to the merchant server 106, indicating the selection of the second product (as shown by arrow 706) by the first group member 102a for purchase. Based on the fifteenth notification, the merchant server 106 may add the second product to the first virtual cart of the first group member 102a (as shown by arrow 708).

The first group member 102a may select the ‘check-out’ option displayed on the second UI for purchasing the second product (as shown by arrow 710). Based on the selection of the ‘check-out’ option, the second service application 120 may display various payment options that may be used to make a payment for the purchase (as shown by arrow 712). The displayed payment options may include the first payment option that allows the first group member 102a to pay for the second product by using the first service application 118.

The first group member 102a may select the first payment option to pay for the second product (as shown by arrow 714). Based on the selection of the first payment option, control may be re-directed from the second service application 120 to the first service application 118 and the first UI of the first service application 118 may be rendered on the display of the first device 104a. The first device 104a may communicate a sixteenth notification to the merchant server 106 indicating the selection of the first payment option (as shown by arrow 716). Based on the sixteenth notification, the merchant server 106 may generate and communicate a second transaction request to the payment network server 110 (as shown by arrow 718). The second transaction request may include details of the first group member 102a and transaction details of a second transaction that is associated with the first group member 102a and corresponds to the purchase of the second product. The transaction details may include as a second transaction amount (e.g., $1,000) of the second transaction (i.e., a price of the piece of jewelry), a product category (for example, ‘Jewelry’) of the second product, the merchant identifier of the first merchant, a transaction reference number of the second transaction, details of an offer available on the second transaction, and/or the like.

Based on the second transaction request, the payment network server 110 may determine whether the first group member 102a is a group member of any virtual group maintained at the payment network server 110 (as shown by arrow 720). The payment network server 110 may determine that the first group member 102a is a group member of the first virtual group. The payment network server 110 may select, from the payment modes that are added to the first virtual group, a second set of payment modes that are most suitable for the second transaction (as shown by arrow 722). In an embodiment, the first merchant may be offering a discount (for example, 30%) on jewelry purchases made using specific types of digital wallets. In a non-limiting example, the second and fourth digital wallets may be eligible for availing the discount on jewelry purchases. Therefore, the second set of payment modes includes the second and fourth payment modes (i.e., the second and fourth digital wallets) and does not include the first and third payment modes.

On selection of the second set of payment modes (i.e., the second and fourth payment modes), the payment network server 110 may communicate a sixth request to the first device 104a (as shown by arrow 724). The payment network server 110 may communicate the sixth request to request the first group member 102a to select a payment mode from the second set of payment modes for initiating the second transaction. The sixth request may be indicative of the second set of payment modes.

With reference to FIG. 7B, based on the sixth request, the first device 104a executing the first service application 118 may present the second set of payment modes on the first UI for selection by the first group member 102a (as shown by arrow 726). The first group member 102a may select any payment mode from the second set of payment modes for carrying out the second transaction. In an exemplary scenario, the first group member 102a selects the fourth payment mode of the third group member 102c for carrying out the second transaction (as shown by arrow 728).

Based on the selection of the fourth payment mode, the first device 104a may communicate a seventeenth notification to the payment network server 110 (as shown by arrow 730). The seventeenth notification may indicate the selection of the fourth payment mode by the first group member 102a. In the current exemplary scenario, the payment network server 110 may communicate a seventh request to the first issuer server 112 to block a first amount from the first payment mode of the first group member 102a that is added to the first virtual group (as shown by arrow 732). The first amount may be determined, by the payment network server 110, based on factors such as the second transaction amount, a discount amount applicable on the second transaction, a service fee, or the like. In the current embodiment, the discount amount is equal to ‘$300’ (i.e., $300=0.30*$1,000). Thus, an effective price of the second product is equal to ‘$700’ (i.e., $700=$1,000−$300). In a non-limiting example, the payment network server 110 may determine that the first amount is equal to ‘$800’. Based on the seventh request, the first issuer server 112 may block ‘$800’ (i.e., the first amount) from the first payment mode of the first group member 102a (as shown by arrow 734). On blocking the first amount, the first issuer server 112 may communicate an eighteenth notification to the payment network server 110, indicating that the first amount is blocked from the first payment mode of the first group member 102a (as shown by arrow 736).

On receiving the eighteenth notification, the payment network server 110 may communicate a third approval request to the third group member 102c for requesting an approval for using the fourth payment mode for initiating the second transaction (as shown by arrow 738). The third approval request may be indicative of the transaction details of the second transaction. In a non-limiting example, the payment network server 110 may reward the third group member 102c with a reward amount if the third group member 102c approves the use of the fourth payment mode for initiating the second transaction. Further, the third approval request may indicate the reward amount (e.g., ‘$100’). The payment network server 110 may determine the first amount and the reward amount by using various algorithms (e.g., machine learning algorithms or artificial intelligence algorithms). Based on the third approval request, the third device 104c executing the first service application 118 may present ninth and tenth options, on the first UI, to the third group member 102c (as shown by arrow 740). The ninth option is for approving the use of the fourth payment mode and the tenth option is for declining the use of the fourth payment mode, for initiating the second transaction. In a non-limiting example, it is assumed that the third group member 102c selects the ninth option and approves the use of the fourth payment mode for initiating the second transaction.

Based on the selection of the ninth option by the third group member 102c, the third device 104c may communicate a third approval response to the payment network server 110 (as shown by arrow 742). The third approval response may indicate the approval of the third group member 102c for initiating the second transaction using the fourth payment mode. For initiating the second transaction using the fourth payment mode, the payment network server 110 may communicate an eighth request to the merchant server 106, requesting the first merchant to use the fourth payment mode for the second transaction (as shown by arrow 744). The eighth request may be indicative of payment mode details of the fourth payment mode.

With reference to FIG. 7C, based on the eighth request, the merchant server 106 may communicate a second authorization request to the first issuer server 112 by way of the payment network server 110 (as shown by arrows 746a and 746b). The first issuer server 112 may authorize the second transaction based on the second authorization request (as shown by arrow 748). The first issuer server 112 may deduct an amount equal to the effective price (i.e., ‘$700’) from the fourth payment mode. The first issuer server 112 may communicate a second authorization response to the merchant server 106 by way of the payment network server 110, indicating that the second transaction is successfully authorized (as shown by arrows 750a and 750b). Based on the second authorization response, the merchant server 106 may communicate a transaction complete notification to the first device 104a to notify the first group member 102a that the second transaction is complete and the second product is successfully purchased by the first group member 102a (as shown by arrow 752).

It will be apparent to those of skill in the art that the first service application 118 may allow the first group member 102a to make transactions at physical stores as well. For example, the first group member 102a may use the first service application 118 to make a purchase at a terminal device (not shown) installed at a first store of a merchant in a manner similar as to that described in FIGS. 5A-5C and 7A-7C.

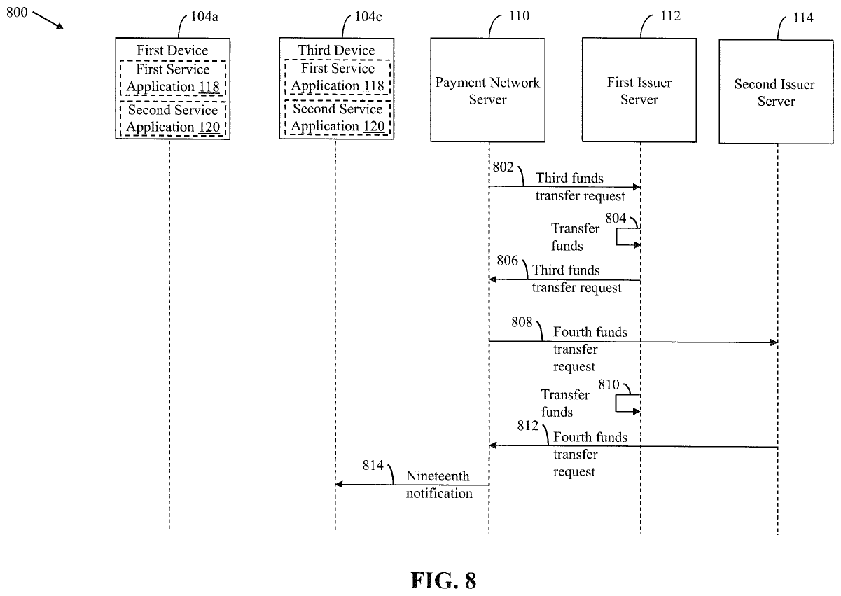

FIG. 8 represents a process flow diagram 800 that illustrates an exemplary scenario for settling the second transaction amount of the second transaction, in accordance with an exemplary embodiment of the disclosure. FIG. 8 is explained in conjunction with FIGS. 1-4 and 7A-7C. The payment network server 110 may facilitate settlement of the first amount (i.e., $800) between the first and third group members 102a and 102c, based on the initiation and successful execution of the second transaction.

For the settlement of the first amount, the payment network server 110 may communicate a third funds transfer request to the first issuer server 112 for transferring the first amount (i.e., $800) to the payment account of the payment network (as shown by arrow 802). The third funds transfer request may be indicative of the ID of the payment account of the payment network and the first amount. Based on the third funds transfer request, the first issuer server 112 may transfer the blocked first amount from the payment account that is linked to the first payment mode of the first group member 102a to the payment account of the payment network (as shown by arrow 804). When funds transfer is successful, the first issuer server 112 may communicate a third funds transfer response to the payment network server 110 (as shown by arrow 806). The third funds transfer response may indicate a successful transfer of the first amount to the payment account of the payment network. Based on the third funds transfer response, the payment network server 110 may communicate a fourth funds transfer request to the second issuer server 114 for transferring a second amount (i.e., $800=$700+$100) that is equal to a sum of the effective price and the reward amount, from the payment account of the payment network to the fourth digital wallet (i.e., the fourth payment mode) of the third group member 102c (as shown by arrow 808). The fourth funds transfer request may be indicative of the payment mode ID of the fourth payment mode and the second amount. Based on the fourth funds transfer request, the second issuer server 114 may transfer the second amount from the payment account of the payment network to the fourth digital wallet (as shown by arrow 810). On transferring the second amount to the fourth digital wallet, the second issuer server 114 may communicate a fourth funds transfer response to the payment network server 110 (as shown by arrow 812). The fourth funds transfer response may indicate a successful transfer of the second amount to the fourth payment mode. On receiving the fourth funds transfer response, the payment network server 110 may communicate a nineteenth notification to the third device 104c (as shown by arrow 814). Based on the nineteenth notification, the third device 104c may present a message to the third group member 102c, indicating that the second amount is successfully transferred to the fourth digital wallet. Thus, the first group member 102a effectively gets a discount of ‘$200’ (i.e., $200=$1000−$800) on the purchase of the second product. The third group member 102c earns a profit of ‘$100’ by allowing the first group member 102a to use the second payment mode for carrying out the second transaction. The payment network earns from the successful transaction.

In one embodiment, the payment network server 110 may implement various machine learning algorithms to determine the reward amount for the second group member 102b. It will be apparent to those of skill in the art the reward amount may be fixed or may be a function of the discount amount.

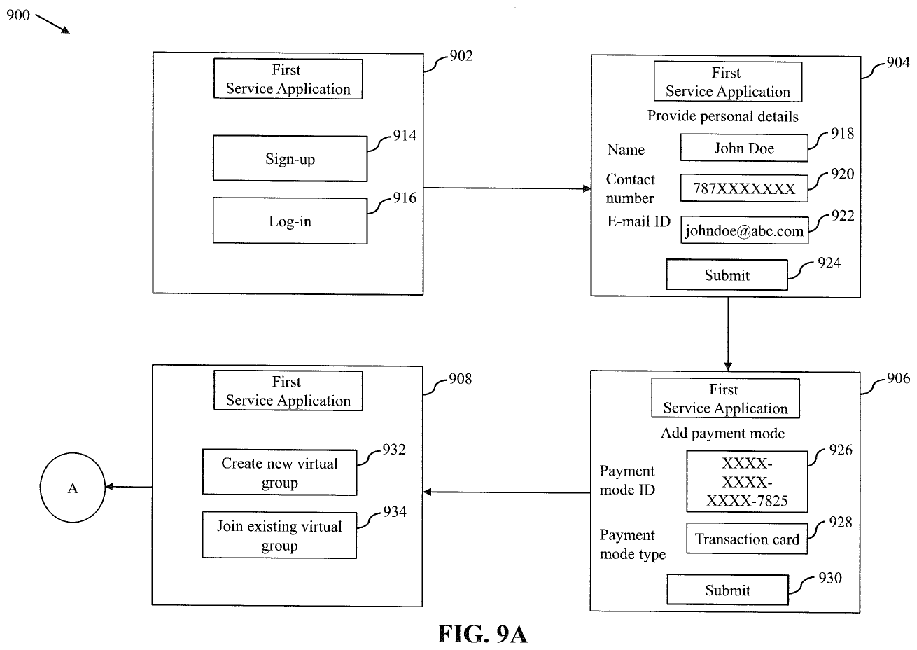

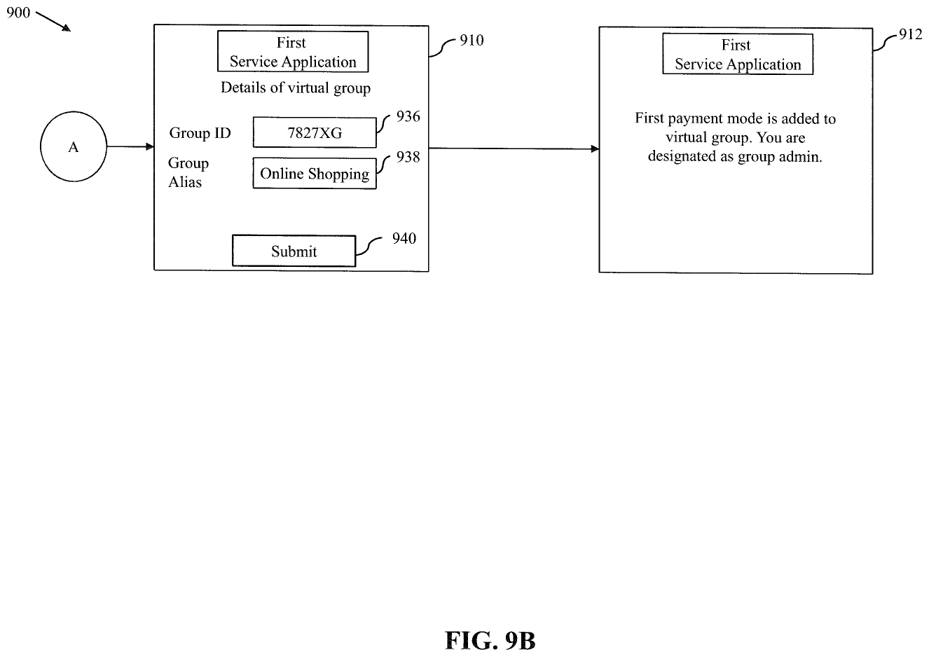

FIGS. 9A and 9B, collectively represent an exemplary scenario 900 that illustrates UI screens 902-912 rendered on the first device 104a, in accordance with an embodiment of the disclosure. FIGS. 9A and 9B have been explained in conjunction with FIGS. 2A and 2B.

When the first user 102a accesses the first service application 118, the payment network server 110 may render the UI screen 902 on the display of the first device 104a by way of the first service application 118. The UI screen 902 may include first and second user-selectable options 914 and 916. The first user-selectable option 914 may allow the first user 102a to sign-up for the first service application 118 if the first user 102a is a first-time user of the first service application 118. The second user-selectable option 916 may allow the first user 102a to log into the first service application 118 if the first user 102a is an existing user of the first service application 118. As described in the foregoing description of FIG. 2A, the first user 102a selects the first user-selectable option 914. When the first user 102a selects the first user-selectable option 914, the payment network server 110 may render the UI screen 904 on the display of the first device 104a by way of the first service application 118.

The UI screen 904 presents a message requesting the first user 102a to enter the personal details of the first user 102a. The UI screen 904 may include first through third text boxes 918, 920, and 922 that allow the first user 102a to enter the name (i.e., ‘John Doe’), a contact number (i.e., ‘787XXXXXXX’), and an email ID (i.e., ‘*johndoe@abc.com’), respectively. It will be apparent to those of skill in the art that the first user 102a may be required to enter additional personal details such as an address of the first user 102a, a social security ID of the first user 102a, or the like. The UI screen 904 may also include a first submit button 924. When the first user 102a selects the first submit button 924, the payment network server 110 may render the UI screen 906 on the display of the first device 104a by way of the first service application 118.

The UI screen 906 may present a message requesting the first user 102a to add a payment mode. The UI screen 906 may include fourth and fifth text boxes 926 and 928 that allow the first user 102a to enter the payment mode ID (i.e., ‘XXXX-XXXX-XXXX-7825’) of the first payment mode and the type (i.e., transaction card) of the first payment mode. It will be apparent to those of skill in the art that the first user 102a may be required to enter more information such as a name of the first issuer, or the like. The UI screen 906 may also include a second submit button 930. When the first user 102a selects the second submit button 930, the first device 104a may communicate the personal details of the first user 102a and the payment mode details of the first payment mode to the payment network server 110. The payment mode details of the first payment mode may be validated by the first issuer server 112 (as described in the foregoing description of the FIG. 2A). Based on the first validation response, the payment network server 110 may communicate the first notification to the first device 104a. When the first device 104a receives the first notification, the payment network server 110 may render the UI screen 908 on the display of the first device 104a by way of the first service application 118.

The UI screen 908 may include third and fourth user-selectable options 932 and 934. The third and fourth user-selectable options 932 and 934 allow the first user 102a to create a new virtual group or join an existing virtual group, respectively. As described in the foregoing description of FIG. 2B, the first user 102a selects the third user-selectable option 932 for creating the first virtual group. When the first user 102a selects the third user-selectable option 932, the payment network server 110 may render the UI screen 910 on the display of the first device 104a by way of the first service application 118.

With reference to FIG. 9B, the UI screen 910 includes sixth and seventh text boxes 936 and 938. The sixth and seventh text boxes 936 and 938 allow the first user 102a to enter the first group ID and the first group alias, respectively. It will be apparent to those of skill in the art that the UI screen 910 may include one or more other fields (not shown) that allow the first user 102a to enter the first set of rules for the first virtual group. The UI screen 910 may also include a third submit button 940.

When the first user 102a selects the third submit button 940 after entering the first group ID, the first group alias, and the first set of rules, the first device 104a may communicate the third notification to the payment network server 110 (as described in the foregoing description of FIG. 2B). Based on the third notification, the payment network server 110 may validate the virtual group details of the first virtual group, create the first virtual group, and add the first payment mode and the first user 102a to the first virtual group. The payment network server 110 may, then, communicate the fourth notification to the first device 104a. When the first device 104a receives the fourth notification, the payment network server 110 may render the UI screen 912 on the display of the first device 104a by way of the first service application 118. The UI screen 912 may display a message indicating that the first virtual group is created, and the first payment mode and the first user 102a are added to the first virtual group. The message may also indicate that the first user 102a is designated is as group admin of the first virtual group.

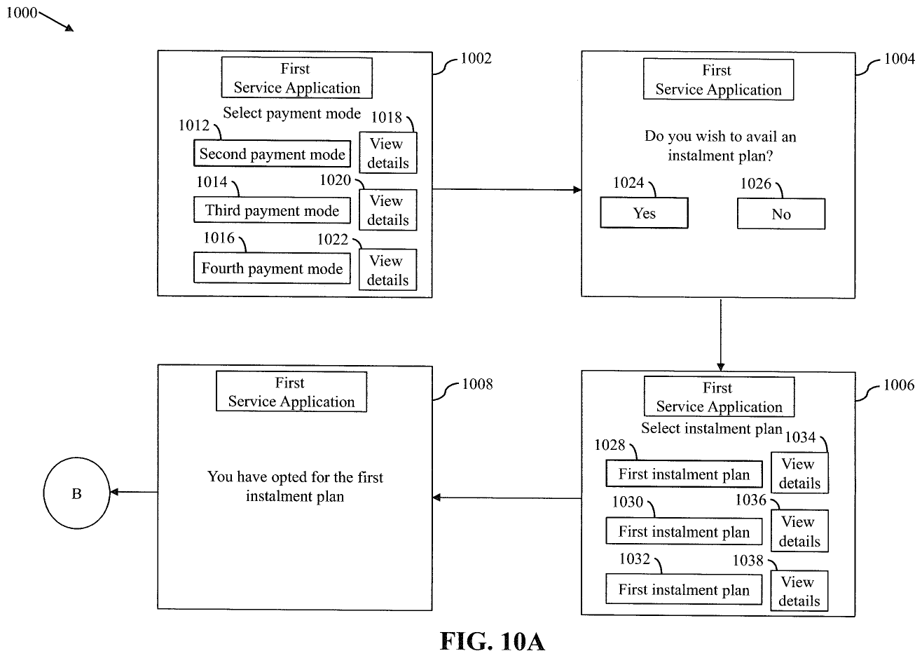

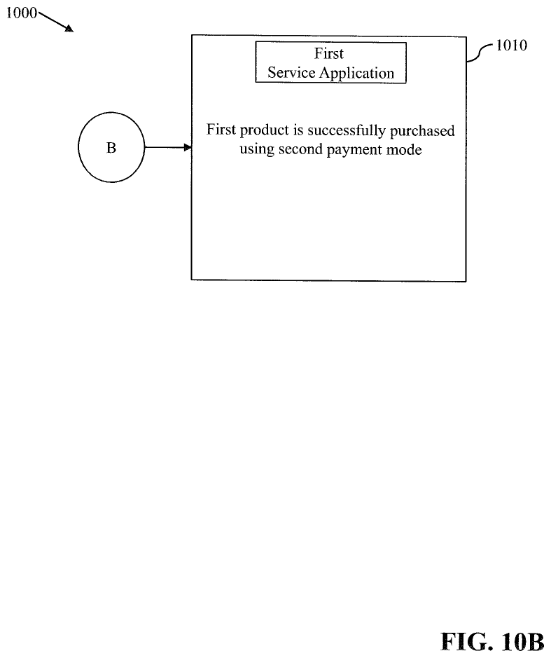

FIGS. 10A and 10B, collectively represent an exemplary scenario 1000 that illustrates UI screens 1002-1010 rendered on the first device 104a, in accordance with another exemplary embodiment of the disclosure. FIGS. 10A and 10B have been explained in conjunction with FIGS. 5A-5C.

The payment network server 110 may render the UI screen 1002 on the display of the first device 104a by communicating the fourth request to the first device 104a. The fourth request may be indicative of the first set of payment modes (e.g., the second, third, and fourth payment modes) selected by the payment network server 110 for the first transaction (as described in the foregoing description of FIG. 5A). The UI screen 1002 may include fifth through tenth user-selectable options 1012-1022. The fifth through seventh user-selectable options 1012-1016 may correspond to the second, third, or fourth payment mode, respectively, and may allow the first group member 102a to select one or more of the second, third, or fourth payment mode for initiating the first transaction. The eighth through tenth user-selectable options 1018-1022, may allow the first group member 102a to view one or more details of the second through fourth payment modes, respectively. As described in the foregoing description of FIG. 5B, the first group member 102a selects the fifth user-selectable option 1012 that corresponds to the second payment mode for initiating the first transaction. When the first group member 102a selects the fifth user-selectable option 1012, the first device 104a may communicate the tenth notification to the payment network server 110. The payment network server 110 may determine the first set of instalment plans and communicate the fifth request, which is indicative of the first set of instalment plans, to the first device 104a. When the first device 104a receives the fifth request, the payment network server 110 may render the UI screen 1004 on the display of the first device 104a by way of the first service application 118.

The UI screen 1004 may display a message, asking the first group member 102a if the first group member 102a wants to settle the first transaction amount through instalments. The UI screen 1004 may include eleventh and twelfth user-selectable options 1024 and 1026. The eleventh user-selectable option 1024 may allow the first group member 102a to avail an instalment plan for settling the first transaction amount. The twelfth user-selectable option 1026 may allow the first group member 102a to decline the settlement of the first transaction amount in instalments. In an exemplary scenario, the first group member 102a may select the eleventh user-selectable option 1024. When the first group member 102a selects the eleventh user-selectable option 1024, the payment network server 110 may render the UI screen 1006 on the display of the first device 104a by way of the first service application 118.

The UI screen 1006 includes a message, requesting the first group member 102a to select an instalment plan. The UI screen 1006 includes thirteenth through eighteenth user-selectable options 1028-1038. The thirteenth through fifteenth user-selectable options 1028-1032 allow the first group member 102a to avail one of the first through third instalment plans, respectively. The sixteenth through eighteenth user-selectable options 1034-1038 allow the first group member 102a to view details (e.g., a rate of interest, a number of instalments, or the like) of the first through third instalment plans, respectively. As described in the foregoing, the first group member 102a selects the thirteenth user-selectable option 1028 (i.e., the first instalment plan). When the first group member 102a selects the thirteenth user-selectable option 1028, the payment network server 110 may render the UI screen 1008 on the display of the first device 104a by way of the first service application 118.

The UI screen 1008 may display a message, indicating that the first user 102a has opted for the first instalment plan. The first device 104a may communicate the eleventh notification, indicating the selection of the first instalment plan, to the payment network server 110 (as described in FIG. 5B). When the first transaction is initiated and successfully executed using the second payment mode selected by the first group member 102a, the UI screen 1010 may be rendered on the display of the first device 104a. As shown in FIG. 10B, the UI screen 1010 may present a message, indicating that the first product is successfully purchased using the second payment mode.

It will be apparent to those of skill in the art that the UI screens 902-912 and the 1002-1010 are merely exemplary and do not limit the scope of the disclosure in any manner.

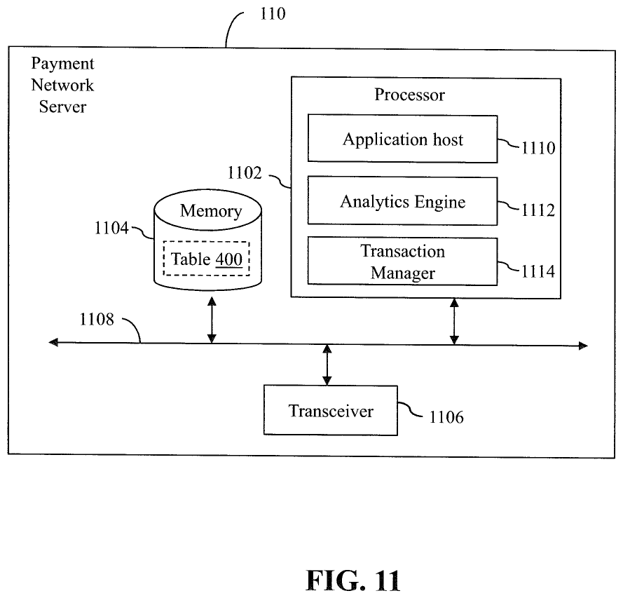

FIG. 11 is a block diagram that illustrates the payment network server 110, in accordance with an embodiment of the disclosure. The payment network server 110 includes a processor 1102, the memory (hereinafter, the memory is referred to as ‘the memory 1104’), and a transceiver 1106. The processor 1102, the memory 1104, and the transceiver 1106 communicate with each other by way of a communication bus 1108. The processor 1102 includes an application host 1110, an analytics engine 1112, and a transaction manager 1114.

The processor 1102 may include suitable logic, circuitry, interfaces, and/or codes, executed by the circuitry, to create virtual groups (e.g., the first and second virtual groups) and facilitate transactions performed by group members (e.g., the first group member 102a) of the virtual groups by using the first service application 118. The processor 1102 may store, in the memory 1104, user profiles (e.g., the first user profile) of the users who are registered with the payment network server 110. For example, the first user profile of the first group member 102a may include the personal details, the payment mode details of the first payment mode of the first group member 102a, and/or the like. The processor 1102 hosts the first service application 118 that is executable on the first through third devices 104a-104c. The processor 1102 may authenticate the first through third group member 102a-102c when the first through third group member 102a-102c attempt to log into the first service application 118.

Examples of the processor 1102 may include, but are not limited to, an application-specific integrated circuit (ASIC) processor, a reduced instruction set computer (RISC) processor, a complex instruction set computer (CISC) processor, a field programmable gate array (FPGA), and the like. The processor 1102 may execute operations for creating virtual groups and facilitating the transactions performed by group members of the virtual group by way of the application host 1110, the analytics engine 1112, and the transaction manager 1114.

The application host 1110 executes operations for hosting the first service application 118 that is executable on various devices, such as the first through third devices 104a-104c. The application host 1110 may control the first service application 118 and may cause the first service application 118 to perform various operations (such as the rendering of the UI screens 902-912 and 1002-1010) as described in FIGS. 9A, 9B, 10A, and 10B. By way of the UI screens 902-912, the application host 1110 allows users (e.g., the first user 102a) to sign-up for the transaction service and avail the transaction service. By way of the UI screens 902-912, the application host 1110 may allow users (e.g., the first user 102a) to sign-up for the first service application 118 and create and/or join virtual groups (e.g., the first virtual group). Further, the application host 1110 may allow group members (e.g., the first group member 102a) of virtual groups (e.g., the first virtual group) to make purchases using payment modes added to the corresponding virtual groups. The application host 1110 may store personal details of users and details of payment modes (e.g., the first payment mode) provided by the users in the memory 1104.

The analytics engine 1112 may receive various transaction requests (such as the first and second transaction requests) from the merchant server 106. For a given transaction that pertains to a purchase (e.g., the first purchase) by a group member of a virtual group (e.g., the first virtual group), the analytics engine 1112 may select, based on transaction details of the transaction and payment modes of group members (e.g., the first, second, and third group members102a, 102b, and 102c) of the virtual group, a set of payment modes (e.g., the first set of payment modes) most suitable for the transaction. The analytics engine 1112 may employ various types of algorithms to select the set of payment modes. The analytics engine 1112 may also determine a set of installment plans (e.g., the first set of instalment plans) for the group member if the analytics engine 1112 determines that the group member is unable to pay a transaction amount of the transaction in one go.

The transaction manager 1114 may facilitate transactions performed by group members of virtual groups for purchases of products and/or services from the first merchant. The transaction manager 1114 may generate and communicate funds transfer requests (such as the first, second, and third funds transfer requests) to issuer servers (such as the first and second issuer servers 112 and 114) for transferring funds among the group members of the virtual groups.

The memory 1104 includes suitable logic, circuitry, interfaces, and/or codes, executable by the circuitry, to store the account profiles of users (such as the first user 102a) and details of payment modes added by the users. The memory 1104 may also store the details of various virtual groups that are maintained at the payment network server 110. For example, the memory 1104 stores Table 400 including all details of the virtual groups. Examples of the memory 1104 may include a random-access memory (RAM), a read-only memory (ROM), a removable storage drive, a hard disk drive (HDD), a flash memory, a solid-state memory, and the like. It will be apparent to a person skilled in the art that the scope of the disclosure is not limited to realizing the memory 1104 in the payment network server 110, as described herein. In another embodiment, the memory 1104 may be realized in form of a database server or a cloud storage working in conjunction with the payment network server 110, without departing from the scope of the disclosure.

The transceiver 1106 includes suitable logic, circuitry, interfaces, and/or codes, executable by the circuitry, for transmitting and receiving data over the communication network 116 using one or more communication network protocols. The transceiver 1106 may transmit various requests and messages to the first through third devices 104a-104c, the merchant server 106, and the first and second issuer servers 112 and 114. The transceiver 1106 may also receive various requests and messages from the first through third devices 104a-104c, the merchant server 106, and the first and second issuer servers 112 and 114. Examples of the transceiver 1106 may include, but are not limited to, an antenna, a radio frequency transceiver, a wireless transceiver, a Bluetooth transceiver, an ethernet port, a universal serial bus (USB) port, or any other device configured to transmit and receive data.

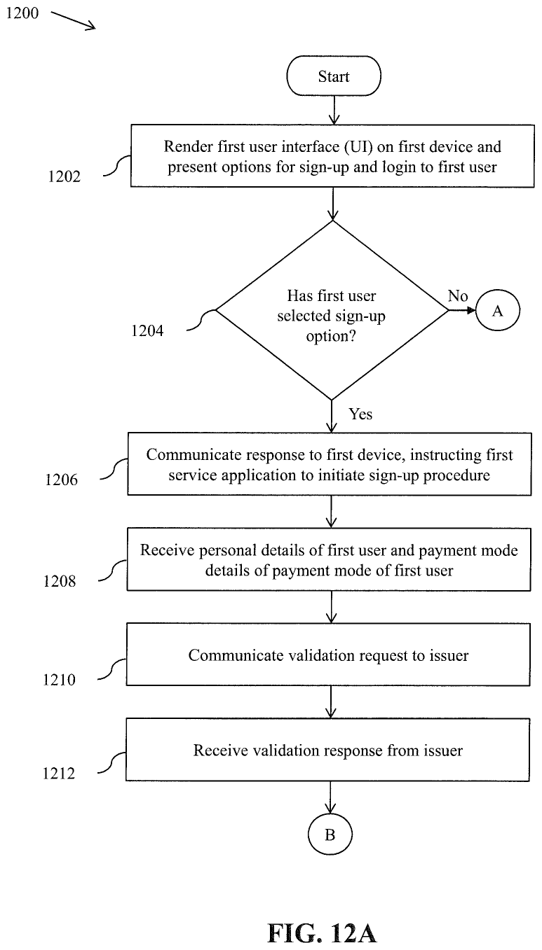

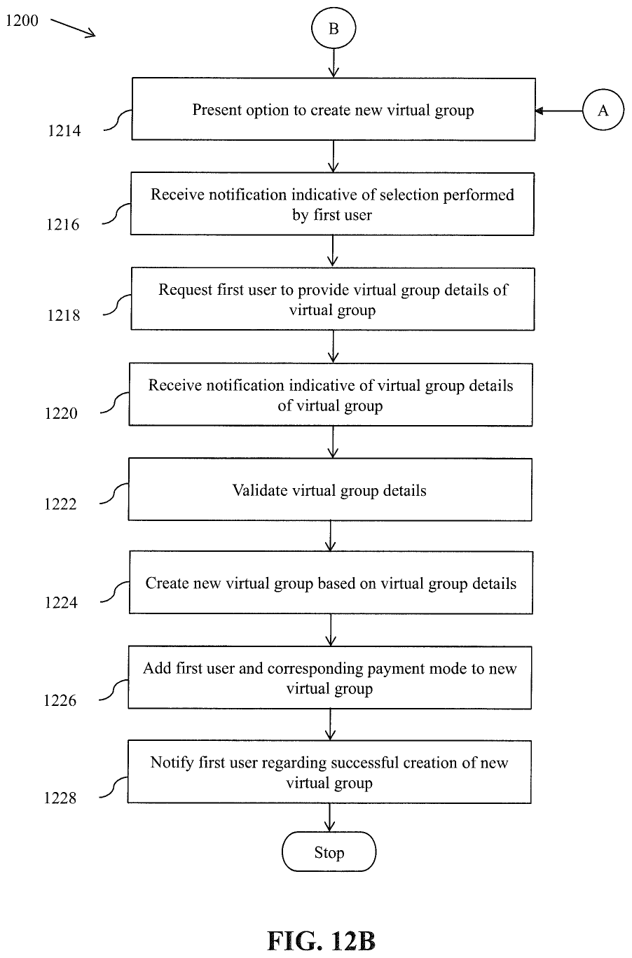

FIGS. 12A and 12B, collectively represent a flow chart 1200 that illustrates the method for creating a virtual group, in accordance with an exemplary embodiment of the disclosure. The first user 102a utilizes the first device 104a for accessing the first service application 118 to create the first virtual group (as described in the foregoing description of FIGS. 2A and 2B).

At step 1202, the first UI may be rendered on the first device 104a when the first user 102a utilizes the first device 104a to access the first service application 118. The first UI may present to the first user 102a, the first and second options to sign-up or login to the first service application 118. The first user 102a may select one of the first and second options. At step 1204, the payment network server 110 may determine whether the first user 102a has selected the first option to sign-up for the first service application 118. If at step 1204, it is determined that the first user 102a has selected the first option to sign-up, step 1206 is performed. At step 1206, the payment network server 110 may communicate to the first device 104a, a response (e.g., the first response as shown in FIG. 2A) that instructs the first service application 118 to initiate the sign-up procedure (as described in the foregoing description of FIG. 2A). Based on the response, the first device 104a may prompt the first user 102a to add payment mode details of payment modes of the first user 102a and personal details of the first user 102a. The first user 102a may enter and submit the payment mode details of payment mode(s) (i.e., the payment mode details of the first payment mode) of the first user 102a and the personal details of the first user 102a. The first device 104a may communicate the payment mode details of the first payment mode and the personal details of the first user 102a to the payment network server 110. At step 1208, the payment network server 110 may receive the payment mode details of the first payment mode and the personal details of the first user 102a. The payment network server 110 may store the personal details of the first user 102a in the first user profile (as described in the foregoing description of FIG. 2A).

At step 1210, the payment network server 110 may communicate a validation request (e.g., the first validation request as shown in FIG. 2A) to the first issuer server 112 for validating the payment mode details of the first payment mode. The first issuer server 112 may validate the payment mode details of the first payment mode. Based on the validation of the payment mode details, the first issuer server 112 may communicate a validation response (e.g., the first validation response) to the payment network server 110. At step 1212, the payment network server 110 may receive the validation response from the first issuer server 112. If at step 1204, it is determined that the first user 102a has selected the second option, step 1214 is performed.

With reference to FIG. 12B, at step 1214, the payment network server 110 may present an option (e.g., the third option as shown in FIG. 2A) that allow the first user 102a to create a new virtual group. The option may be displayed on the first UI rendered on the first device 104a. The first user 102a may select the presented option to create a new virtual group. At step 1216, the payment network server 110 may receive, from the first device 104a, a notification (e.g., the second notification) that is indicative of the selection of the presented option (i.e., the third option) by the first user 102a. At step 1218, based on the notification, the payment network server 110 may request the first user 102a to provide virtual group details of the virtual group that is to be created. In one embodiment, the payment network server 110 may communicate a request (e.g., the second request as shown in FIG. 2B) to the first device 104a for requesting the first user 102a to provide the virtual group details of the virtual group that is to be created. The first user 102a may provide the virtual group details of the first virtual group, and the first device 104a may communicate, to the payment network server 110, a notification (e.g., the third notification) indicative of the virtual group details provided by the first user 102a (as described in the foregoing description of FIG. 2B).

At step 1220, the payment network server 110 may receive, from the first device 104a, the notification indicating the virtual group details of the first virtual group. At step 1222, the payment network server 110 may validate the virtual group details (as described in the foregoing description of FIG. 2B). At step 1224, the payment network server 110 may create the first virtual group based on the virtual group details. At step 1226, the payment network server 110 may add the first user 102a and the first payment mode of the first user 102a to the first virtual group. The payment network server 110 may also designate the first user 102a as the first group admin of the first virtual group. At step 1228, payment network server 110 may notify the first user 102a on successful creation of the first virtual group. The payment network server 110 may communicate a notification (e.g., the third notification as shown in FIG. 2B) to the first device 104a, indicating that the first user 102a is added to the first virtual group.

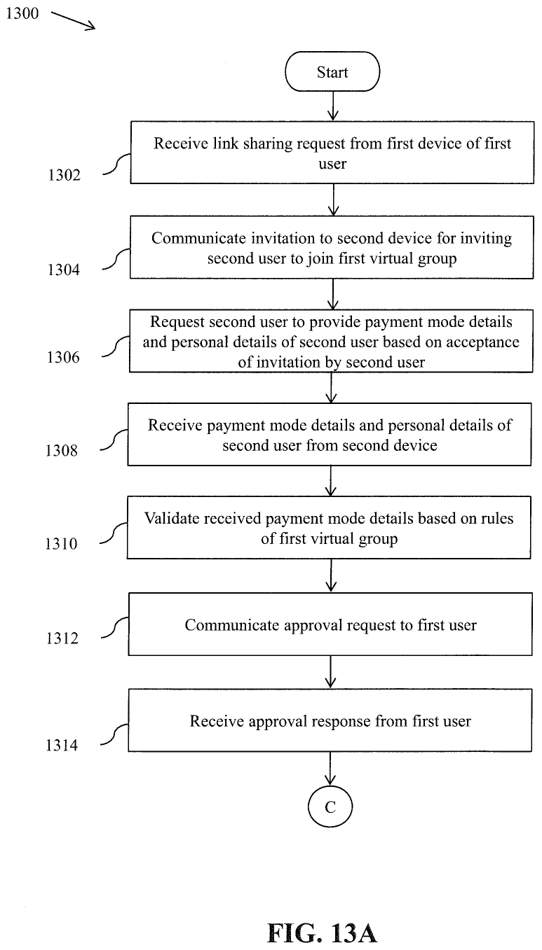

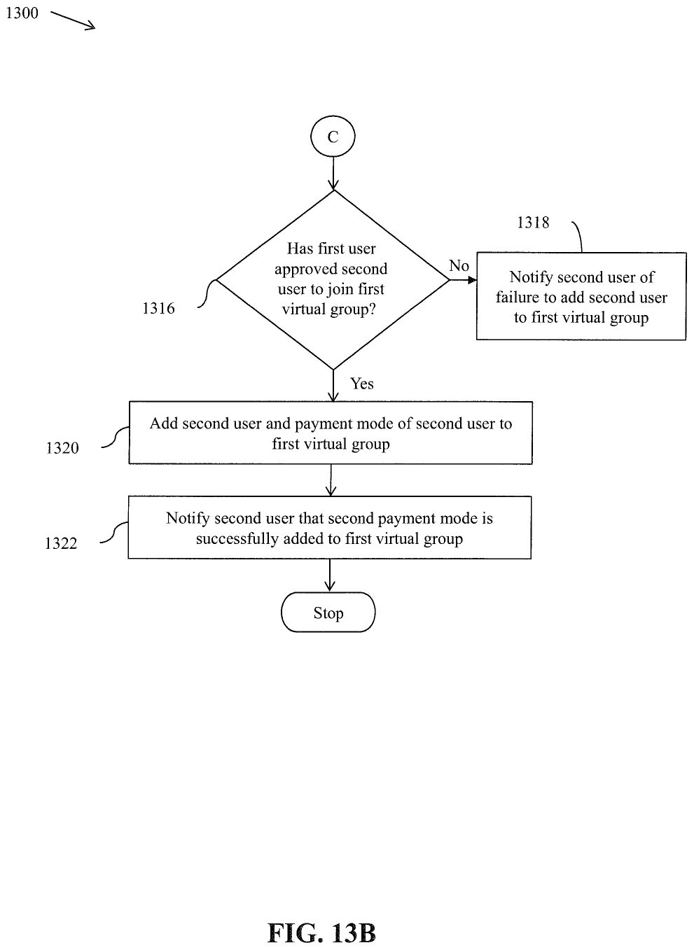

FIGS. 13A and 13B, collectively represent a flow chart 1300 that illustrates the method for adding group members to a virtual group, in accordance with an embodiment of the disclosure. For the sake of brevity, the method for adding new group members to a virtual group is described with reference to the first virtual group, the first user 102a, who is the first group admin of the first virtual group, and the second user 102b who is invited to join the first virtual group. The first group member 102a may utilize the first device 104a to access the first service application 118 for adding new group members to the first virtual group.

At step 1302, the payment network server 110 may receive the link sharing request from the first device 104a of the first user 102a, as described in the foregoing description of FIG. 3A. The link sharing request may be a request for inviting another user (e.g., the second user 102b) to join the first virtual group as a group member. At step 1304, the payment network server 110 may communicate an invitation the second device 104b of the second user 102b for inviting the second user 102b to join the first virtual group. For example, the payment network server 110 may communicate an invite link (e.g., the first invite link as shown in FIG. 3A) to the second device 104b of the second user 102b as an invitation to join the first virtual group. The second user 102b may select the first invite link (as described in the foregoing description of FIG. 3A) to accept the invitation. At step 1306, the payment network server 110 may request the second user 102b to provide payment mode details of a payment mode of the second user 102b and personal details of the second user 102b. The second user 102b may provide payment mode details of the second payment mode.

At step 1308, the payment network server 110 may receive, from the second device 104b, the payment mode details of the second payment mode and the personal details of the second user 102b. At step 1310, the payment network server 110 may validate the received payment mode details based on the first set of rules associated with the first virtual group (as described in the foregoing descriptions of FIGS. 3A and 3B). In other words, the payment network server 110 may validate the second payment mode to ensure conformity with the first set of rules associated with the first virtual group. At step 1312, the payment network server 110 may communicate an approval request (e.g., the first approval request) to the first device 104a, requesting the first user 102a to approve the second user 102b to join the first virtual group (as described in the foregoing description of FIG. 3B). The first user 102a may approve or decline the first approval request. Based on whether the first user 102a approves or declines the first approval request, the first device 104a may communicate an approval response (e.g., the first approval response as shown in FIG. 3B) to the payment network server 110. At step 1314, the payment network server 110 may receive the approval response (e.g., the first approval response as shown in FIG. 3B) from the first device 104a.

With reference to FIG. 13B, at step 1316, the payment network server 110 may determine, based on the approval response, whether the first user 102a has approved the second user 102b to join the first virtual group. If at step 1316, it is determined that the first user 102a has not approved the second user 102b to join the first virtual group, step 1318 is performed. At step 1318, the payment network server 110 may notify the second user 102b of a failure to add the second user 102b to the first virtual group. If at step 1316, it is determined that the first user 102a has approved the second user 102b to join the first virtual group, step 1320 is performed. At step 1320, the payment network server 110 may add the second user 102b and the second payment mode to the first virtual group. At step 1322, the payment network server 110 may notify the second user 102b that the second payment mode and the second user 102b are successfully added to the first virtual group. In one embodiment, the payment network server 110 may communicate a notification (e.g., the second notification as shown in FIG. 3B) to the second device 104b to notify the second user 102b.

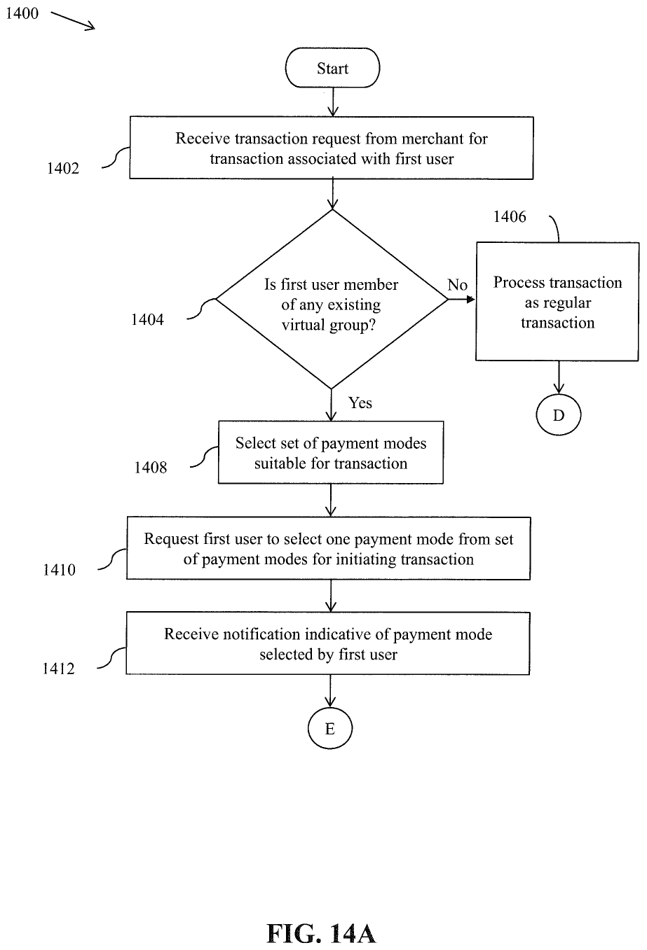

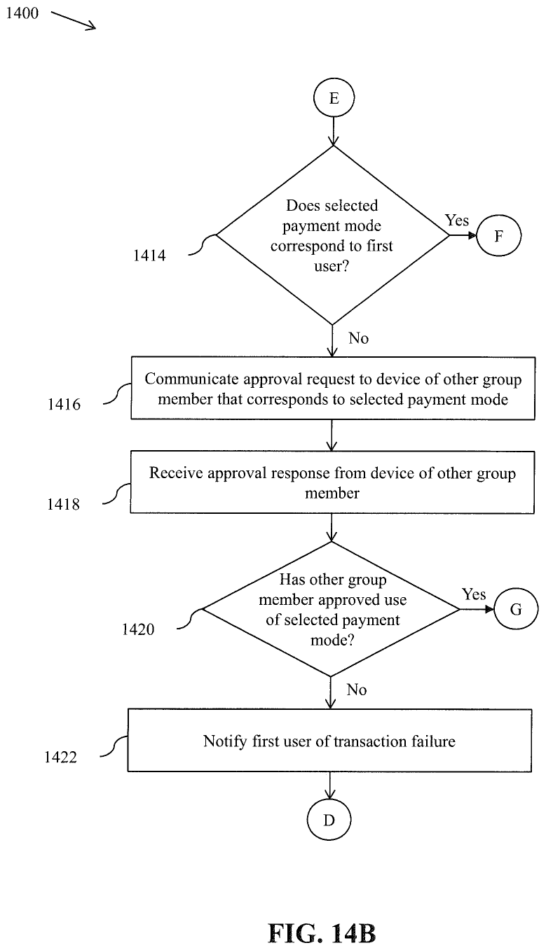

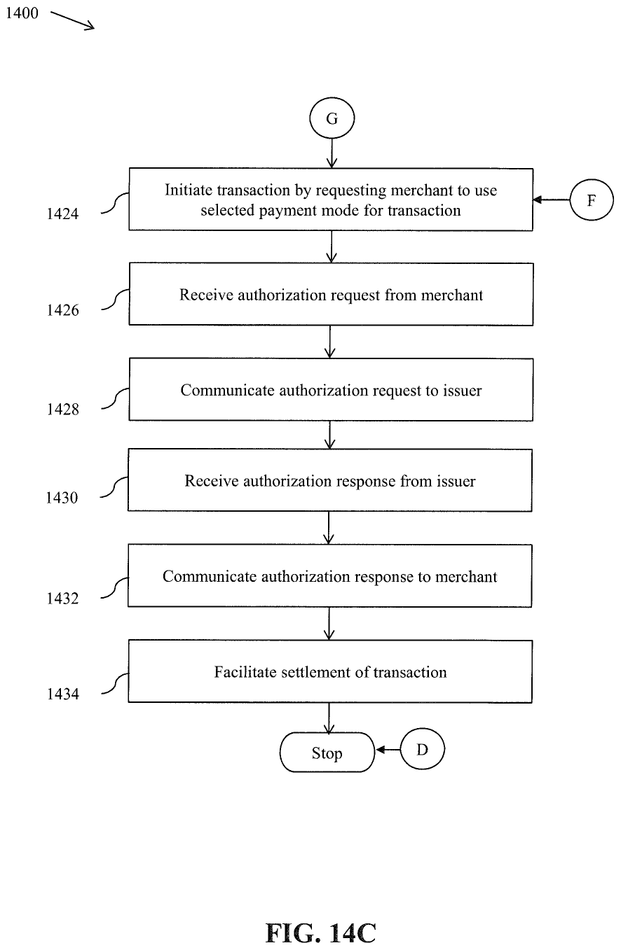

FIGS. 14A-14C, collectively represent a flow chart 1400 that illustrates the method for facilitating transactions, in accordance with an embodiment of the disclosure. For the sake of brevity, the method for facilitating transactions is described with reference to the first virtual group and the first user 102a who is a group member of the first virtual group. The first user 102a may utilize the first device 104a to make a purchase.

At step 1402, the payment network server 110 may receive, from the merchant server 106, a transaction request (e.g., the first transaction request or the second transaction request of FIGS. 5A and 7A) for a transaction (e.g., the first transaction or the second transaction) associated with the first user 102a. The transaction request may pertain to a purchase of one or more products and/or services from the first merchant by the first user 102a. At step 1404, the payment network server 110 may determine whether the first user 102a is a group member of any existing virtual group. If at step 1404, it is determined that the first user 102a is not a member of any virtual group, step 1406 is performed. At step 1406, the payment network server 110 may process the transaction as a regular transaction. In one embodiment, the payment network server 110 may communicate a request to the first device 104a, requesting the first user 102a to provide payment mode details of a payment mode to be used for carrying out the transaction. The first device 104a may communicate the payment mode details provided by the first user 102a to the payment network server 110. The payment network server 110 may use the payment mode details to process the transaction as a regular transaction.

If at step 1404, it is determined that the first user 102a is a group member of a virtual group (e.g., the first virtual group), step 1408 is performed. At step 1408, the payment network server 110 may select, from payment modes that are added to the first virtual group associated with the first user 102a, a set of payment modes (e.g., the first or the second set of payment modes) that are most suitable for the transaction. At step 1410, the payment network server 110 may request the first user 102a to select one payment mode from the set of payment modes for initiating the transaction. In one embodiment, the payment network server 110 may communicate, to the first device 104a, a request (e.g., the fourth request) for requesting the first group member 102a to select a payment mode from the set of payment modes. Based on the request, the first device 104a may present the set of payment modes to the first user 102a for selection (as described in the foregoing descriptions of FIGS. 5A and 7A). The first user 102a may select, from the presented set of payment modes, a payment mode for carrying out the transaction. Based on the selection by the first user 102a, the first device 104a may communicate, to the payment network server 110, a notification (e.g., the tenth notification) that is indicative of the payment mode selected by the first user 102a. At step 1412, the payment network server 110 may receive, from the first device 104a, the notification that is indicative of the payment mode selected by the first user 102a.

With reference FIG. 14B, at step 1414, the payment network server 110 may determine whether the payment mode selected by the first user 102a corresponds to the first user 102a. If at step 1414, it is determined that the payment mode selected by the first user 102a does not correspond to the first user 102a, step 1416 is performed. At step 1416, the payment network server 110 may communicate an approval request to a device of another group member that corresponds to the selected payment mode, for requesting an approval for initiating the transaction using the selected payment mode. For example, the selected payment mode may be a payment mode of the second user 102b who is also a group member of the first virtual group. Thus, the payment network server 110 may communicate the approval request to the second device 104b of the second user 102b. Based on the approval request, the other group member may approve or decline the use of the selected payment mode for initiating the transaction. When the other group member approves or declines the use of the selected payment mode for initiating transaction, the device of the other group member may communicate an approval response to the payment network server 110. At step 1418, the payment network server 110 may receive the approval response from the device of the other group member. At step 1420, the payment network server 110 may determine, based on the approval response, whether the other group member has approved the use of the selected payment mode for initiating the transaction. If at step 1420, it is determined that the other group member has not approved the use of the selected payment mode for initiating the transaction, step 1422 is performed. At step 1422, the payment network server 110 may notify the first user 102a of a failure of the transaction. The payment network server 110 may communicate a notification to the first device 104a indicating that the other group member has declined the use of the selected payment mode for initiating the transaction and may request the first user 102a to select another payment mode from the set of payment modes. If at step 1422, it is determined that the other group member has approved the use of the selected payment mode for initiating the transaction, step 1424 (as shown in of FIG. 14C) is performed. If at step 1414, it is determined that the selected payment mode corresponds to the first group member 102a, step 1424 is performed.

With reference to FIG. 14C, at step 1424, the payment network server 110 may initiate the transaction by requesting the merchant server 106 to use the selected payment mode for the transaction. The payment network server 110 may communicate, to the merchant server 106, a request (e.g., the eighth request) that is indicative of the payment mode details of the selected payment mode. The merchant server 106 may communicate an authorization request (e.g., the first authorization request) to the payment network server 110. At step 1426, the payment network server 110 may receive the authorization request from the merchant server 106. At step 1428, the payment network server 110 may communicate the authorization request to the first issuer server 112 associated with the selected payment mode. At step 1430, the payment network server 110 may receive an authorization response from the first issuer server 112 (as described in the foregoing descriptions of FIGS. 5C and 7C). At step 1432, the payment network server 110 may communicate the authorization response to the merchant server 106. The merchant server 106 may notify the first user 102a regarding the successful purchase from the first merchant (as described in the foregoing descriptions of FIGS. 5C and 7C). At step 1434, the payment network server 110 may facilitate a settlement of the transaction (as described in the foregoing descriptions of FIGS. 6 and 8).

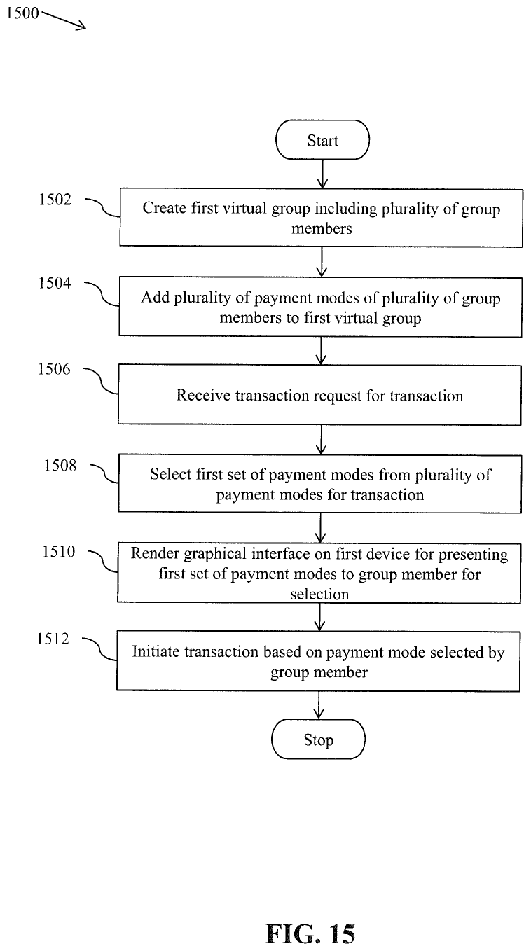

FIG. 15 represents a high-level flow chart 1500 that illustrates the method for facilitating transactions, in accordance with an embodiment of the present disclosure. At step 1502, the payment network server 110 may create the first virtual group that includes a plurality of group members (for example, the first through third group members 102a-102c). In one example, the payment network server 110 may add the first user 102a to the first virtual group as group member based on the group creation request initiated by the first user 102a. The payment network server 110 may communicate invitations to the second and third users 102b and 102c to join the first virtual group and when the second and third users 102b and 102c accept the invitations, the payment network server 110 may add the second and third users 102b and 102c to the first virtual group as group members.

At step 1504, the payment network server 110 may add a plurality of payment modes of the plurality of group members (for example, the first through fourth payment modes of the first through third group members 102a-102c) to the first virtual group. The second through fourth payment modes of the second and third users 102b and 102c may be added to the first virtual group based on the acceptance of the invitations by the second and third users 102b and 102c. At step 1506, the payment network server 110 may receive a transaction request for a transaction associated with a group member (e.g., the first group member 102a) of the first virtual group. At step 1508, the payment network server 110 may select, from the plurality of payment modes added to the first virtual group, a first set of payment modes that is suitable for initiating the transaction. The selection of the first set of payment modes may be based on at least one of a transaction amount of the transaction, an eligibility of the first set of payment modes to avail one or more benefits on the transaction, or a credit limit of each of the first set of payment modes. At step 1510, the payment network server 110 may render a graphical interface on the first device 104a of the first group member 102a, for presenting the first set of payment modes for selection by the first group member 102a of the first virtual group. At step 1512, the payment network server 110 may initiate the transaction using a payment mode (e.g., the first through fourth payment modes) selected by the first group member 102a from the first set of payment modes. The payment mode selected by the first group member 102a is associated with another group member of the first virtual group.

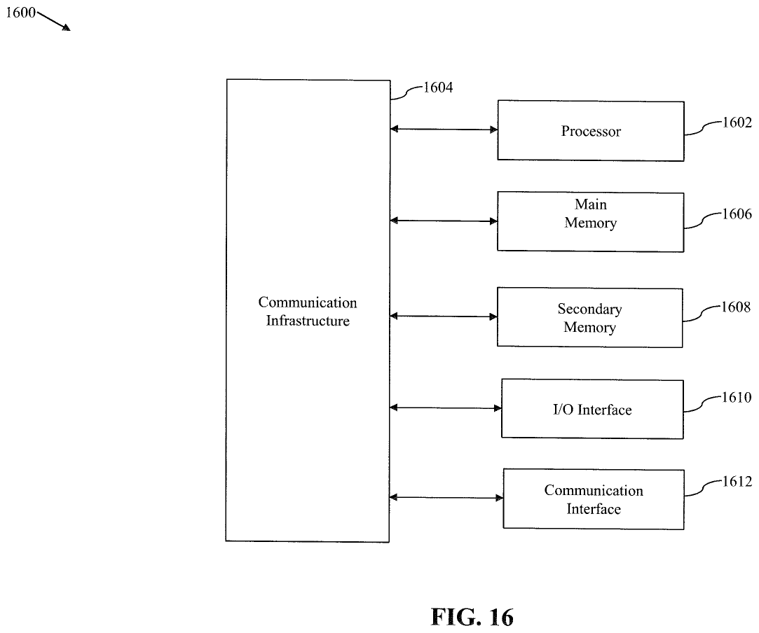

FIG. 16 is a block diagram that illustrates system architecture of a computer system 1600, in accordance with an embodiment of the disclosure. An embodiment of disclosure, or portions thereof, may be implemented as computer readable code on the computer system 1600. In one example, the first through third devices 104a-104c, the merchant server 106, the payment network server 110, and the first and second issuer servers 112 and 114 of FIG. 1 may be implemented in the computer system 1600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 12-15.

The computer system 1600 includes a processor 1602 that may be a special-purpose or a general-purpose processing device. The processor 1602 may be a single processor, multiple processors, or combinations thereof. The processor 1602 may have one or more processor cores. In one example, the processor 1602 is an octa-core processor. The processor 1602 may be connected to a communication infrastructure 1604, such as a bus, message queue, multi-core message-passing scheme, and the like. The computer system 1600 may also include a main memory 1606 and a secondary memory 1608. Examples of the main memory 1606 may include RAM, ROM, and the like. The secondary memory 1608 may include a hard disk drive or a removable storage drive, such as a floppy disk drive, a magnetic tape drive, a compact disc, an optical disk drive, a flash memory, and the like. The removable storage drive may read from and/or write to a removable storage device in a manner known in the art. In one example, if the removable storage drive is a compact disc drive, the removable storage device may be a compact disc. In an embodiment, the removable storage unit may be a non-transitory computer readable recording media.

The computer system 1600 further includes an input/output (I/O) interface 1610 and a communication interface 1612. The I/O interface 1610 includes various input and output devices that are configured to communicate with the processor 1602. Examples of the input devices may include a keyboard, a mouse, a joystick, a touchscreen, a microphone, and the like. Examples of the output devices may include a display screen, a speaker, headphones, and the like. The communication interface 1612 may be configured to allow data to be transferred between the computer system 1600 and various devices that are communicatively coupled to the computer system 1600. Examples of the communication interface 1612 may include a modem, a network interface, i.e., an Ethernet card, a communication port, and the like. Data transferred via the communication interface 1612 may correspond to signals, such as electronic, electromagnetic, optical, or other signals as will be apparent to a person skilled in the art. The signals may travel via a communication channel (not shown) which may be configured to transmit the signals to devices that are communicatively coupled to the computer system 1600. Examples of the communication channel may include, but are not limited to, cable, fiber optics, a phone line, a cellular phone link, a radio frequency link, and the like.

The main memory 1606 and the secondary memory 1608 may refer to non-transitory computer readable mediums. These to non-transitory computer readable mediums may provide data that enables the computer system 1600 to implement the methods illustrated in FIGS. 12-15. In an embodiment, the disclosure is implemented using a computer implemented application, the computer implemented application may be stored in the main memory 1606 and/or the secondary memory 1608.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into digitally any device. For instance, at least one processor such as the processor 1602 and a memory such as the main memory 1606 and the secondary memory 1608 implements the above described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Thus, the environment 100 enhances a convenience of performing transactions by allowing users (such as the first through third users 102a-102c) to avail the transaction service. Technological improvements in the payment network server 110 enable the payment network server 110 to offer the transaction service to various users. Group admins (e.g., the first group admin) of virtual groups (e.g., the first and second virtual groups as shown in FIG. 4) are authorized to restrict entry to the corresponding virtual groups by setting rules (e.g., the first set of rules) for the virtual groups. For example, the group admins may allow only close acquaintances of the corresponding group members to join the virtual groups, thus, establishing a level of trust between the group members of the corresponding virtual groups. By way of the transaction service offered by the payment network server 110, a group member of a virtual group (for example, the first through third group members 102a-102c) is able to perform transactions using payment modes of other group members of the same virtual group. As a result, the group member avoids a need to maintain multiple payment modes for making transactions, enhancing a convenience of the group member. Further, a group member of a virtual group, whose payment mode is used by another group member of the same virtual group, may benefit monetarily by allowing other group member (such as the first user 102a) to perform transactions using corresponding payment modes. Users (e.g., the first through third users 102a-102c), who are group members of virtual groups, may ramp up purchases of products and/or services from merchants (e.g., the first merchant), owing to a convenience of performing transactions using the first service application 118. As a result, the merchants, the payment networks, and the issuers may achieve increased business.

Techniques consistent with the disclosure provide, among other features, systems and methods for facilitating transactions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

In the claims, the words ‘comprising’, ‘including’ and ‘having’ do not exclude the presence of other elements or steps then those listed in a claim. The terms “a” or “an,” as used herein, are defined as one or more than one. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

What is claimed is:

1. A method for facilitating transactions, the method comprising:
creating, by a server, a first virtual group including a plurality of group members;
adding, by the server, to the first virtual group, a plurality of payment modes of the plurality of group members;
receiving, by the server, a transaction request for a transaction associated with a first group member of the first virtual group;
selecting, by the server, from the plurality of payment modes, a first set of payment modes suitable for the transaction;
rendering, by the server on a first device of the first group member, a graphical interface for presenting the first set of payment modes to the first group member for selection; and
initiating, by the server, the transaction using a first payment mode selected by the first group member from the first set of payment modes, wherein the first payment mode selected by the first group member is associated with a second group member of the first virtual group.

2. The method of claim 1, wherein each payment mode of the plurality of payment modes is one of a transaction card or a digital wallet.

3. The method of claim 1, further comprising communicating, by the server, one or more invitations to one or more users for inviting the one or more users to join the first virtual group, wherein the one or more users are added to the first virtual group as one or more group members based on an acceptance of the one or more invitations by the one or more users, and wherein the plurality of group members include the one or more group members.

4. The method of claim 3, wherein one or more payment modes of the one or more users are added to the first virtual group based on the acceptance of the invitation by the one or more users, and wherein the plurality of payment modes include the one or more payment modes.

5. The method of any of claims 1, further comprising storing, by the server, one or more parameters associated with the first virtual group in a database, wherein the one or more parameters associated with the first virtual group include at least one of a group identifier of the first virtual group, a plurality of usernames of the plurality of group members, or a plurality of payment mode identifiers of the plurality of payment modes.

6. The method of any of claims 1, further comprising facilitating, by the server, a settlement of a transaction amount of the transaction between the first and second group members based on the initiation of the transaction.

7. The method of any of claims 1, wherein the selection of the first set of payment modes is based on at least one of a transaction amount of the transaction, an eligibility of the first set of payment modes to avail one or more benefits on the transaction, or a credit limit of each of the first set of payment modes.

8. The method of any of claims 1, wherein the first set of payment modes is same as the plurality of payment modes.

9. The method of any of claims 1, further comprising communicating, by the server, to a second device of the second group member, an approval request for requesting an approval of the second group member for using the first payment mode for initiating the transaction.

10. The method of claim 9, further comprising receiving, by the server, from the second device, an approval response based on the approval request, wherein the approval response indicates the approval of the second group member for using the first payment mode for initiating the transaction, and wherein the transaction is initiated by the server based on the approval response.

11. A system for facilitating transactions, the system comprising a server that is configured to:
create a first virtual group including a plurality of group members,
add, to the first virtual group, a plurality of payment modes of the plurality of group members,
receive, a transaction request for a transaction associated with a first group member of the first virtual group,
select, from the plurality of payment modes, a first set of payment modes suitable for the transaction,
render, on a first device of the first group member, a graphical interface for presenting the first set of payment modes to the first group member for selection, and
initiate the transaction using a first payment mode selected by the first group member from the first set of payment modes, wherein the first payment mode selected by the first group member is associated with a second group member of the first virtual group.

12. The system of claim 11, wherein each payment mode of the plurality of payment modes is one of a transaction card or a digital wallet.

13. The system of claim 11, wherein the server is further configured to communicate one or more invitations to one or more users for inviting the one or more users to join the first virtual group, wherein the one or more users are added to the first virtual group as one or more group members based on an acceptance of the one or more invitations by the one or more users, and wherein the plurality of group members include the one or more group members.

14. The system of claim 13, wherein the server adds one or more payment modes of the one or more users to the first virtual group based on the acceptance of the invitation by the one or more users, and wherein the plurality of payment modes include the one or more payment modes.

15. The system of any of claims 11, wherein the server is configured to store one or more parameters associated with the first virtual group in a database, and wherein the one or more parameters associated with the first virtual group include at least one of a group identifier of the first virtual group, a plurality of usernames of the plurality of group members, or a plurality of payment mode identifiers of the plurality of payment modes.

16. The system of any of claims 11, wherein the server is further configured to facilitate a settlement of a transaction amount of the transaction between the first and second group members based on the initiation of the transaction.

17. The system of any of claims 11, wherein the server selects the first set of payment modes based on at least one of a transaction amount of the transaction, an eligibility of the first set of payment modes to avail one or more benefits on the transaction, or a credit limit of each of the first set of payment modes.

18. The system of any of claims 11, wherein the first set of payment modes is same as the plurality of payment modes.

19. The system of any of claims 11, wherein the server is further configured to communicate, to a second device of the second group member, an approval request for requesting an approval of the second group member for using the first payment mode for initiating the transaction.

20. The system of claim 19, wherein the server is further configured to receive, from the second device, an approval response based on the approval request, wherein the approval response indicates the approval of the second group member for using the first payment mode for initiating the transaction, and wherein the transaction is initiated by the server based on the approval response.
